(19) United States
(12) Patent Application Publication
(10) Pub. No.: US 2021/0045296 A1
(43) Pub. Date: Feb. 18, 2021

(54) AIRFLOW SYSTEM AND METHOD FOR A CHAMBER

(71) Applicant: TERRACUBE INTERNATIONAL INC., Victoria, BC (CA)

(72) Inventors: Renee GAGNON, Victoria (CA); Dana FERGUSON, Victoria (CA); Neil GILBERT, Victoria (CA)

(21) Appl. No.: 16/965,579

(22) PCT Filed: Jan. 31, 2019
(86) PCT No.: PCT/CA2019/050118

§ 371 Date: Jul. 28, 2020

Related U.S. Application Data
(60) Provisional application No. 62/624,675, filed on Jan. 31, 2018.

(51) Int. Cl. A01G 9/24

(52) U.S. Cl. CPC A01G 9/246

(57) ABSTRACT

A cultivation system and method. Conditioned airflow is directed downwardly and in crosswise opposition into a sealed cultivation chamber. The conditioned airflow passes through plants in the chamber, strengthening the plants, transferring heat, humidity and CO₂, and scrubbing the plants of infectious particles, resulting in spent airflow. The spent airflow is recovered from the chamber below where the conditioned airflow was introduced. The spent airflow is conditioned and reintroduced to the chamber as conditioned airflow. A volume of the conditioned airflow directed into the chamber is substantially equal to a volume of the spent airflow received from the chamber, and a volume of the spent airflow in the system between receiving the airflow and conditioning the airflow is substantially equal to a volume of the conditioned airflow in the system between conditioning the airflow and directing the airflow, for maintaining consistent airflow within the chamber.

### CROSS-REFERENCE TO RELATED APPLICATIONS

This application claims the benefit of priority of U.S. Provisional Patent Application No. 62/624,675, filed Jan. 31, 2018 and entitled “AIRFLOW SYSTEM AND METHOD FOR CULTIVATION”, which is incorporated herein by reference in its entirety.

### FIELD

The present disclosure relates to airflow control in a chamber.

### BACKGROUND

Cultivation of high-value crops with precise levels of control over growing conditions is increasingly important as our understanding of plant medicine expands and the market for precision-grown crops increases.

A key determinant of success in precision cultivation is the cleanliness and lack of infectious agents in a grow room. One obstacle to maintaining a clean grow room is that a high level of heat and humidity is often present as a result of heat from lighting, humidity begin retained on the surface of plants, and humidity and heat stored in growth media being released. However, these high levels of heat and humidity also create an ideal environment for mould and other pests to thrive. These problems may be exacerbated by the lack of wind and airflow in indoor cultivation facilities, which allow spores and other infectious agents to have greater residency time on plant tissue. In some cases fans used to cool the grow rooms contribute to mobilizing spores and other infectious agents.

There is call for improved approaches to managing the environment inside a precision cultivation chamber.

### SUMMARY

Herein provided are a system and method for providing consistent crosswise and downward airflow in a controlled cultivation environment. Plants with woody stalks will change morphology, stalk strength and other factors depending on the amount of wind that they are exposed to. There are advantages for some crops to be grown in a windier environment depending on the goals of the cultivator. Such advantages may be considered in view of advantages in terms of reproducibility and batch consistency that are afforded by cultivating indoors in a controlled environment. Some previous attempts to achieve the benefits of a windy environment suffer from drawbacks including uneven airflow resulting in bent stalks, ineffective or counterproductive mixing of warm and cold air, ineffectively or counterproductively pushing cold air and CO₂ upwards, and contamination of the grow area.

Roof vents in greenhouses cannot be used for temperature control due to contamination risk. An alternative is to use large amounts of air conditioning energy to cool a large building with single-pane glass during a sunny day. Grow lights in a greenhouse or indoor grow room are often so high that the greenhouse or grow room must be drastically over-lit to compensate resulting in hundreds of thousands of dollars in wasted light energy, which in the case of a greenhouse bleeds into the night sky causing significant light pollution. In addition, significant amounts of energy must be used to heat and control humidity in a large single-pane glass building during cool times and seasons.

In terms of airflow, both greenhouses and traditional indoor grows use powerful fans to blow sideways across the crop to disrupt thermal layering. However, the fans also blow any bacteria and mold spoors throughout the crop, potentially contaminating the entire greenhouse or indoor grow.

In summary, greenhouse and indoor growing rooms suffer from minimal available active internal atmosphere sterilization or external smell emission control. Human entry and exit to the greenhouse or grow room, particularly when on a regular basis, significantly raises the chance of bacterial or mold contamination. These problems are exacerbated by minimal crop segmentation or isolation. When an infestation starts, millions of square feet of crops may be lost in a matter of days with little or no possible recovery options. Finally, where security is an issue, greenhouses particularly require significant amounts of physical perimeter security.

The method described herein includes, and the system described herein facilitates, effective airflow control in a sealed cultivation chamber. Conditioned airflow is directed downwardly and in crosswise opposition into the sealed cultivation chamber. The airflow may be conditioned in terms of its relative humidity, temperature, oxygen saturation, CO₂ levels, or other factors relevant to plant growth. While travelling downwardly and crosswise through the chamber, the air tumbles through leaves, stems, flowers, fruits and other portions of plants growing in the chamber, providing the benefits of wind exposure to the crop being cultivated.

The crosswise nature of the airflow is balanced crosswise from left to right to avoid pushing the plants over, while still stressing xylem, which in turn stresses the plants and induces morphological changes. The airflow scrubs the surfaces of the leaves, removing spores, viruses, bacteria and other infectious agents from the surfaces of the leaves and stems. The downward motion of the airflow scrubs particles and material downward, pushing infectious agents to the floor. Vessels with a tapered shape and a narrow aperture to accommodate a plant stalk without a great amount of clearance around the stalk, may mitigate growth media from infection. The narrow aperture may also be plugged with silicone or any suitable material to further mitigate entry of infectious particles into the vessel and associated infection of growth media within the vessel. In addition, as the air runs downward across the surface of the plants the air scrubs the surfaces of the plants, cleaning the surface and acting as a humidity, heat and CO₂ exchanger.

An intake proximate the bottom of the sealed cultivation chamber receives spent airflow and the spent airflow is provided to a conditioning system to again provide conditioned airflow before being redirected downwardly and in crosswise opposition into the chamber. The conditioning system includes filtration to remove particles and contaminants through a coarse particle filter. The conditioning system may include a chemical purification filter, such as a charcoal filter or a HEPA filter. The conditioning system may include a moisture droplet removal system, a heat exchanger, a humidifier, a desiccator, a UV or other electromagnetic energy source to kill microorganisms, or other conditioning equipment. CO₂ or an atmospheric gas blend may be added to the airflow. Any cooling or addition of CO₂ may be added to the airflow above the point at which the conditioned airflow is directed into the chamber to allow the relatively greater density CO₂ and cool air, compared with warmer air, to drop downward through the chamber.

A consistent and high level of airflow is directed at the plants downwardly and in crosswise opposition. The consistency and the intensity of the airflow, and its crosswise nature, keep a constant level of stress on the stems for inducing changes. In addition, the consistent downward flow may contribute to effectively scrubbing the plants for cleaning, and exchanging humidity, temperature and CO₂ with, the plants. A sufficient velocity and effective dispersal of airflow may be provided by flowing the conditioned airflow into the antechamber through one or more pairs of nozzles and one or more diffusers. With the nozzles pointing inward and downward from across the chamber's width and proximate the ceiling of the chamber, and the diffuser between the nozzles along the width, a crosswise and downward airflow that tumbles through the plants may be provided. The consistency is also facilitated by keeping the airflow into the chamber through the nozzles and the diffusers, and the airflow out of the chamber through the intakes, equal or substantially equal to each other, and within 20% (as used at any point herein, meaning within any of 20, 19, 18, 17, 16, 15, 14, 13, 12, 11, 10, 9, 8, 7, 6, 5, 4, 3, 2 or 1%). The greater the difference in volume, the more disruptive that the difference will be to even airflow. In addition, a volume of the spent airflow between the intake and the conditioning system is substantially equal to a volume of the conditioned airflow between conditioning the airflow and a return to directing the airflow, and within 20%, which may also facilitate consistency of airflow. Airflow consistency within the chamber is also facilitated by tuning successive nozzles and diffusers, and also successive intakes or portions of a unified intake, with greater surface-area orifices the further that the nozzles, diffuser, intakes or portions of a unified intake are from the conditioning unit and source of airflow.

The airflow system facilitates continuous upgrading and refreshing of the air quality and sterility are as the airflow recirculates through the conditioning system, which may include HVAC and UVC sterilization lamps, to mitigate the presence of airborne infectious agents. The airflow also facilitates consistent humidity and temperature are consistent from the canopy to the root as conditioned sterile air flows down from the ceiling through the canopy and out the intakes near the floor. The airflow disrupts thermal layers that facilitate growth of mold and spread of bacteria. The thermal layers may be disrupted without the use of traditional wall-mounted circulation fans that blow sideways through the crop, spreading any mold or bacteria across the entire grow area. In addition, the continuous directed angular wind may agitate the canopy sufficiently to cause plant stalks and branches to grow significantly thicker, reducing the need for traditional strings and supports. In addition, by disrupting the thermal layers, need for plant spacing is mitigated, allowing greater crop density and system efficiency.

Other features may be included in the sealed cultivation chamber to maintain cleanliness and facilitate turnover after a crop is harvested. A floor may be shaped with a sloped portion that periodically resets along the length of the chamber, for facilitating cleaning of the chamber by spraying. The periodic reset of the floor slope allows for modular construction of chambers of varying length while maintaining advantages of easy cleaning and draining. During cultivation, the sloped portion and the drain would be covered by floorboards to provide an even walking surface. A spraying system may also be included to flood the chamber with disinfectant fluids following harvest and during preparation for a new harvest.

The method and system provided herein may also be applied in applications other than cultivation to provide airflow control in a chamber. The method and system may be applied to a building, motor vehicle cab, aircraft, motorhome dwelling area, kitchen, smoking lounge, vaping lounge, or any suitable chamber. The chamber may also include cultivation areas that are not sealed and for which airflow is recirculated without conditioning. Incoming airflow is directed downwardly and in crosswise opposition into the chamber. The incoming airflow may be conditioned in terms of its relative humidity, temperature, oxygen saturation, CO₂ levels, or other factors relevant to the environment in the chamber. While travelling downwardly and crosswise through the chamber, the air pushes vapour, smoke or other particulates, pests, viruses or other infectious agents, odour or other airborne environmental features downward. The method and system may mitigate the presence of head-level carcinogens that result from smoking in an enclosed area by sweeping smoke to the floor. Conditioning of the outgoing airflow may have particular effectiveness for applications directed to providing a safe environment for smoking or vaporizing cannabis, tobacco, other plants, plant extracts or manufactured vaporization solutions.

The crosswise nature of the airflow may be balanced from left to right to mitigate exposing people and objects in the chamber to a net airflow in one direction. The airflow scrubs surfaces, removing spores, viruses, bacteria and other infectious agents from the surfaces within the chamber. The downward motion of the airflow scrubs particles and material downward, pushing infectious agents to the floor.

An intake proximate the bottom of the chamber receives spent airflow and the airflow may be provided to a conditioning system to again provide incoming airflow before again being directed downwardly and in crosswise opposition into the chamber. The conditioning system includes filtration to remove particles and contaminants through a coarse particle filter and may include a moisture droplet removal system, a charcoal filter, a HEPA filter, a heat exchanger, a humidifier, a desiccator, or other conditioning equipment. Fresh air, oxygen or an atmospheric gas blend may be added to the airflow. Any cooling or addition of gasses, liquids or particulates may be added to the airflow above the point at which the conditioned airflow is directed into the chamber.

A consistent and adjustable level of airflow is directed downwardly and in crosswise opposition. The consistency and the intensity of the airflow, and its crosswise nature, maintain a consistent air flow. The consistent downward flow may contribute to effectively blowing odour, smoke, infectious particles, pests and other undesirable airborne particulates or other environmental features downward toward the floor. The airflow may also serve to maintain clean surfaces, and exchanging humidity and temperature with people or objects in the chamber. A sufficient velocity and effective dispersal of airflow may be provided by flowing the conditioned airflow into the chamber through one or more pairs of nozzles and one or more diffusers. With the nozzles pointing inward and downward from across the chamber's width and proximate the ceiling of the chamber, and the diffuser between the nozzles along the width, a crosswise and downward airflow that tumbles through the chamber may be provided.

Consistency of airflow is also facilitated by keeping the airflow into the chamber through the nozzles and the diffusers, and the airflow out of the chamber through the intakes, equal or substantially equal to each other, and within 20%. The greater the difference in volume, the more disruptive that the difference will be to even airflow. In addition, a volume of the spent airflow between the intake and the conditioning system is substantially equal to a volume of the conditioned airflow between conditioning the airflow and a return to directing the airflow, and within 20%, which may also facilitate consistency of airflow. Airflow consistency within the chamber is also facilitated by tuning successive nozzles and diffusers with greater diameter orifices the further they are from the conditioning unit and source of airflow.

In a first aspect, herein provided is a cultivation system and method. Conditioned airflow is directed downwardly and in crosswise opposition into a sealed cultivation chamber. The conditioned airflow passes through plants in the chamber, strengthening the plants, transferring heat, humidity and CO2, and scrubbing the plants of infectious particles, resulting in spent airflow. The spent airflow is recovered from the chamber below where the conditioned airflow was introduced. The spent airflow is conditioned and reintroduced to the chamber as conditioned airflow. A volume of the conditioned airflow directed into the chamber is substantially equal to a volume of the spent airflow received from the chamber, and a volume of the spent airflow in the system between receiving the airflow and conditioning the airflow is substantially equal to a volume of the conditioned airflow in the system between conditioning the airflow and directing the airflow, for maintaining consistent airflow within the chamber.

In a further aspect, herein provided is a cultivation system comprising: a body defining a sealed cultivation chamber therein; an output on the body for directing airflow downwardly and in crosswise opposition into the chamber; an intake below the output for receiving the airflow from the output; a conduit between the intake and the output for providing airflow communication from the intake to the output; a conditioning system in airflow communication with the conduit for conditioning the airflow after being received by the intake for return to the output; and an input in airflow communication with the conduit for providing additional input material to the conduit. The cross-sectional area of the output is substantially equal to the cross-sectional area of the intake for maintaining consistent airflow within the chamber. A first portion of the conduit between the intake and the conditioning system is substantially equal in volume to a second portion of the conduit between the conditioning system and the output

In some embodiments, the body comprises modular components connected with each other. In some embodiments, the modular components comprise a first endwall, a second endwall, at least two sidewalls, at least one floor component and at least one roof component. In some embodiments, first endwall includes a doorway for access to the chamber. In some embodiments, the chamber is overpressured to a first pressure that is greater than atmospheric pressure. In some embodiments, the system includes an antechamber component connected to the body at the first endwall. In some embodiments, the chamber is overpressured to a first pressure that is greater than atmospheric pressure. In some embodiments, the antechamber is overpressured to a second pressure that is greater than atmospheric pressure and that is below the first pressure. In some embodiments, each of the at least one of the floor components slopes downwardly from a first end to a second end at a grade along a sloped portion, and each of the at least one floor components comprises a drain at the second end. In some embodiments, the at least one floor components comprise at least two floor components, the grade of each floor component is equal, a height at the first end of each floor component is equal, and a height at the second end of each floor component is equal, for resetting the height and the grade on each successive sloped portion. In some embodiments, the system includes a walkway panel reversibly mountable over the sloped portion and the drain of each floor component. In some embodiments, the modular components include flanged connection points extending from each of the modular components externally to the body for connecting the components In some embodiments, the system includes a plurality of cleaning orifices in the body for forcefully providing cleaning fluids to the chamber to clean and sanitize the chamber. In some embodiments, the chamber is overpressured to a first pressure that is greater than atmospheric pressure. In some embodiments, the system includes an antechamber in the body for providing access to the chamber. In some embodiments, the antechamber is overpressured to a second pressure that is greater than atmospheric pressure and that is below the first pressure. In some embodiments, the output comprises: a pair of nozzles located across at least a portion of the width of the chamber from each other for directing the airflow downwardly into the chamber at a first angle and at a second angle; and a diffuser located intermediate the pair of nozzles along the width for directing the airflow downwardly into the chamber; wherein the first angle and the second angle are substantially equal in the magnitudes of their respective horizontal and vertical components and opposed across a width of the chamber for converging within the chamber. In some embodiments, the diffuser is located intermediate the pair of nozzles along the width for directing the airflow vertically downward into the chamber. In some embodiments, the system includes a plurality of pairs of nozzles and a plurality of diffusers; and each of the plurality of pairs of nozzles and each of the plurality of diffusers are regularly spaced located along a length of chamber, the length being perpendicular to the width; each of the plurality of nozzles and diffusers is calibrated for greater cross-sectional area with increasing distance from to conditioning system for providing consistent output of airflow along the length of the chamber; and the intake is calibrated to for greater cross-sectional area with increasing distance from the conditioning system for providing consistent intake of airflow along the length of the chamber. In some embodiments, each diffuser of the plurality of diffusers is located intermediate a pair of nozzles of the plurality of pairs of nozzles along the width for directing the airflow vertically downward into the chamber. In some embodiments, the first angle and the second angle are each equal to between 40 and 50 degrees. In some embodiments, the first angle and the second angle are selected to converge the airflow from the pair of nozzles on a position or expected position of plants being cultivated in the chamber. In some embodiments, the intake is on a downward-facing contour of the body to facilitate cleaning by spraying from above without spraying into the intake. In some embodiments, the conduit comprises a first plenum extending along a length of the body from the intake to the conditioning system. In some embodiments, the first plenum is defined within a sidewall of the body. In some embodiments, the system includes an outer shell within which the body is received and wherein the first plenum is defined between a sidewall and the outer shell. In some embodiments, the conduit comprises a second plenum extending along a length of the body from the conditioning system to the output. In some embodiments, the second plenum is defined on a roof of the body. In some embodiments, the second plenum is defined within a roof component of the body. In some embodiments, the system includes an outer shell within which the body is received and wherein the second plenum is defined between a roof component of the body and the outer shell. In some embodiments, the input is in airflow communication with a source of CO₂ and the second plenum. In some embodiments, the second portion is located at an upper part of the body and above the output, and the input is in airflow communication with the second portion for providing the additional input material to the conduit input at the second portion. In some embodiments, the conditioning system comprises a moisture droplet removal system intermediate the intake and the particulate filter. In some embodiments, the conditioning system comprises a chemical purification filter intermediate the particulate filter and the output. In some embodiments, the conditioning system comprises a heat exchanger for heating or cooling the airflow. In some embodiments, the heat exchanger is in airflow communication with the conduit for heating or cooling the airflow in a portion of the conduit located above the output. In some embodiments, the conditioning system comprises a humidity control system for raising or lowering the relative humidity of gas in the airflow. In some embodiments, the input is in airflow communication with a source of CO₂. In some embodiments, the input is in airflow communication with a portion of the conduit located above the output for providing airflow communication between the source of CO₂ and the portion of the conduit located above the output. In some embodiments, the input is in airflow communication with a source of purified air. In some embodiments, the system includes a plurality of cleaning orifices in the body for forcefully providing cleaning fluids to the chamber to clean and sanitize the chamber.

In a further aspect, herein provided is a cultivation method comprising: providing a sealed cultivation chamber; directing conditioned airflow downwardly and in crosswise opposition into the chamber, resulting in spent airflow; recovering the spent airflow from the chamber; conditioning the spent airflow after being received from the chamber, resulting in the conditioned airflow; and flowing the conditioned airflow toward the chamber for directing the conditioned airflow downwardly and in crosswise opposition into the chamber, resulting in the spent airflow. A volume of the conditioned airflow being directed into the chamber is substantially equal to a volume of the spent airflow being received from the chamber for maintaining consistent airflow within the chamber. A volume of the spent airflow between receiving the airflow and conditioning the airflow is substantially equal to A volume of the conditioned airflow between conditioning the airflow and a return to directing the airflow.

In some embodiments, the chamber is overpressured above atmospheric pressure. In some embodiments, conditioning comprises filtering out particulates. In some embodiments, conditioning comprises removing droplets. In some embodiments, conditioning comprises controlling humidity. In some embodiments, conditioning comprises applying chemical purification. In some embodiments, conditioning comprises exchanging heat. In some embodiments, exchanging heat to lower the temperature of the conditioned airflow is provided to the conditioned airflow above a point where the airflow is directed into the chamber. In some embodiments, the method includes providing additional input material to the conditioned airflow. In some embodiments, the input material comprises CO₂. In some embodiments, the CO₂ is provided to the conditioned airflow above a point where the airflow is directed into the chamber. In some embodiments, the method includes directing cleaning fluids under pressure into the chamber through a plurality of cleaning orifices and draining the fluids from the chamber. In some embodiments, the cleaning fluid comprises a cleaning chemical in solvent. In some embodiments, the cleaning chemical has a first boiling point; the solvent has a second boiling point; the first boiling point is lower than the second boiling point; and the method further comprises increasing the temperature in the chamber to a temperature between the first boiling point and the second boiling point for boiling the cleaning chemical and exposing the chamber to gaseous cleaning chemical. In some embodiments, the cleaning chemical comprises Cl2 and the solvent comprises water.

In a further aspect, herein provided is a cultivation vessel comprising: a tapered body extending between a narrow first end and a wide second end, the body defining a cavity therein for receiving growth medium and holding roots of a plant; an aperture defined proximate the first end for accommodating a stalk of a plant growing from growth media in the cavity; a mouth defined proximate the second end for receiving growth media and allowing fluids to drain from the body; and a lid for connecting with the mouth for holding the growth medium within the cavity. The aperture is narrower than the mouth and the body is tapered for facilitating flow of particles downward along the body.

In some embodiments, the aperture is at the first end. In some embodiments, the cultivation vessel includes a plug in the aperture for mitigating entry of infectious particles into cavity.

In a further aspect, herein provided is an airflow system and method. Airflow is directed downwardly and in crosswise opposition into a chamber. The airflow passes through the chamber, moving odour, infectious particles and pests downward. The spent airflow is recovered from the chamber below where it was introduced then conveyed back into the chamber in the same downward and in crosswise opposed manner, beginning the cycle again. A volume of the airflow being directed into the chamber is substantially equal to a volume of the airflow being received from the chamber for maintaining consistent airflow within the chamber.

In a further aspect, herein provided is an airflow system comprising: a body defining a chamber therein; an output on the body for directing airflow downwardly and in crosswise opposition into the chamber; an intake below the output for receiving the airflow from the output; and an airflow source in airflow communication with the output. The cross-sectional area of the output is substantially equal to the cross-sectional area of the intake for maintaining consistent airflow within the chamber.

In some embodiments, the output comprises: a pair of nozzles located across at least a portion of the width of the chamber from each other for directing the airflow downwardly into the chamber at a first angle and at a second angle; and a diffuser located intermediate the pair of nozzles along the width for directing the airflow downwardly into the chamber; and the first angle and the second angle are substantially equal in the magnitudes of their respective horizontal and vertical components and opposed across a width of the chamber for converging within the chamber. In some embodiments, the diffuser is located intermediate the pair of nozzles along the width for directing the airflow vertically downward into the chamber. In some embodiments, the system includes In some embodiments, a plurality of pairs of nozzles and a plurality of diffusers; each of the plurality of pairs of nozzles and each of the plurality of diffusers are regularly spaced located along a length of chamber, the length being perpendicular to the width; each of the plurality of nozzles and diffusers is calibrated for greater cross-sectional area with increasing distance from to airflow source for providing consistent output of airflow along the length of the chamber; the intake is calibrated to for greater cross-sectional area with increasing distance from the airflow source for providing consistent intake of airflow along the length of the chamber. In some embodiments, each diffuser of the plurality of diffusers is located intermediate a pair of nozzles of the plurality of pairs of nozzles along the width for directing the airflow vertically downward into the chamber. In some embodiments, the first angle and the second angle are each equal to between 40 and 50 degrees. In some embodiments, the first angle and the second angle are selected to converge the airflow from the pair of nozzles on a target position in the chamber. In some embodiments, the intake is on a downward-facing contour of the body to facilitate cleaning by spraying from above without spraying into the intake. In some embodiments, the system includes an input in airflow communication with the output for providing input material to the output. In some embodiments, the system includes a conduit between the intake and the output for providing airflow communication from the intake to the output. In some embodiments, the conduit comprises a first plenum extending along a length of the body from the intake to the airflow source. In some embodiments, the first plenum is defined within a sidewall of the body. In some embodiments, the conduit comprises a second plenum extending along a length of the body from the airflow source to the output. In some embodiments, the second plenum is defined on a roof of the body. In some embodiments, the second plenum is defined within the roof. In some embodiments, the system includes a covering over the roof and wherein the second plenum is defined between the roof and the covering. In some embodiments, the system includes an input in airflow communication with the conduit, and in airflow communication with a source of input material for providing additional input material to the conduit. In some embodiments, the input is in airflow communication with the conduit at a portion of the body above the output. In some embodiments, the input material comprises purified air. In some embodiments, the input material comprises scented material or coloured material. In some embodiments, the input is in airflow communication with a portion of the conduit located above the output for providing airflow communication between the source of input material and the portion of the conduit located above the output. In some embodiments, the system includes a conditioning system in airflow communication with the conduit for conditioning the airflow after being received by the intake for return to the output and wherein a first portion of the conduit between the intake and the conditioning system is substantially equal in volume to a second portion of the conduit between the conditioning system and the output. In some embodiments, the conditioning system comprises a particulate filter. In some embodiments, the conditioning system comprises a moisture droplet removal system intermediate the intake and the particulate filter. In some embodiments, the conditioning system comprises a heat exchanger for heating or cooling the airflow. In some embodiments, the heat exchanger is in airflow communication with the conduit for heating or cooling the airflow in a portion of the conduit located above the output. In some embodiments, the conditioning system comprises a humidity control system for raising or lowering the relative humidity of gas in the airflow.

In a further aspect, herein provided is an airflow method comprising: providing a chamber; directing incoming airflow downwardly and in crosswise opposition into the chamber, resulting in outgoing airflow; and recovering the outgoing airflow from the chamber. A volume of the incoming airflow being directed into the chamber is substantially equal to a volume of the outgoing airflow being received from the chamber for maintaining consistent airflow within the chamber.

In some embodiments, the method includes providing input material to the incoming airflow. In some embodiments, the input material comprises purified air. In some embodiments, the input material comprises scented material or coloured material. In some embodiments, the additional input material is provided to the airflow above a point where the airflow is directed into the chamber. In some embodiments, recovering the outgoing airflow comprises flowing the outgoing airflow back to the chamber as incoming airflow. In some embodiments, conditioning the outgoing airflow after being received from the chamber, resulting in conditioned airflow; and flowing the conditioned airflow toward the chamber for directing the conditioned airflow downwardly and in crosswise opposition into the chamber, resulting in the spent airflow. The volume of the spent airflow between receiving the outgoing airflow and conditioning the outgoing airflow is substantially equal to the volume of the conditioned airflow between conditioning the airflow and a return to directing the airflow. In some embodiments, conditioning comprises filtering out particulates. In some embodiments, conditioning comprises removing droplets. In some embodiments, conditioning comprises controlling humidity. In some embodiments, conditioning comprises applying chemical purification. In some embodiments, conditioning comprises exchanging heat. In some embodiments, exchanging heat to lower the temperature of the conditioned airflow is provided to the conditioned airflow above a point where the airflow is directed into the chamber.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached figures, in which reference numerals having a common final two digits refer to corresponding features across figures (e.g. the body 20, 120, 220, 320, 420, 520, 620, 720 etc.):

FIG. 1 is a perspective view of a cultivation system;

FIG. 2 is a partial cutaway perspective view of the cultivation system of FIG. 1;

FIG. 3 is a perspective view of a body of the cultivation system of FIG. 1;

FIG. 4 is an exploded view of the body of FIG. 3;

FIG. 5 is an elevation view of a cultivation chamber in the body of FIG. 3;

FIG. 6 is a perspective view of the cultivation chamber of FIG. 3 being exposed to airflow;

FIG. 7 shows the body of FIG. 3 and airflow through plenums defined by the body;

FIG. 8 is an elevation view of plants being cultivated inside the cultivation chamber of FIG. 5;

FIG. 9 is a perspective view of a cultivation vessel;

FIG. 10 is an elevation view of a cultivation vessel;

FIG. 11 is a plan view of a cultivation vessel;

FIG. 12 is a cross-section view of a cultivation vessel;

FIG. 13 is an elevation view of a cultivation vessel body;

FIG. 14 is a plan view of a cultivation vessel body;

FIG. 15 is a cross-section view of a cultivation vessel body;

FIG. 16 is an elevation view of a cultivation vessel lid;

FIG. 17 is a plan view of a cultivation vessel lid;

FIG. 18 is a cross-section view of a cultivation vessel lid;

FIG. 19 is a perspective view of the body of FIG. 3 during cleanout;

FIG. 20 is a perspective view of a floor component;

FIG. 21 is an elevation view of a floor component;

FIG. 22 is perspective view of a cultivation system;

FIG. 23 is perspective view of a cultivation system;

FIG. 24 is an elevation view of a cultivation chamber in the cultivation system of FIG. 23;

FIG. 25 is an elevation view of plants being cultivated inside the cultivation chamber of FIG. 24;

FIG. 26 is the cultivation chamber of FIG. 24 with the plants at a later stage of growth and the table lowered to maintain airflow on the plants;

FIG. 27 is the cultivation chamber of FIG. 24 with the plants at a later stage of growth and the angle of nozzles adjusted to maintain airflow on the plants;

FIG. 28 is perspective view of an antechamber of the cultivation system of FIG. 3;

FIG. 29 is an elevation view of a sidewall;

FIG. 30 is a plan view of a sidewall;

FIG. 31 is a plan view of a roof component;

FIG. 32 is an elevation view of a roof component;

FIG. 33 is a cross-section of the cultivation system of FIG. 1 showing the cultivation chamber and the antechamber;

FIG. 34 is a plan view of the roof components of the growth chamber and the antechamber;

FIG. 35 is a perspective view of connections between the roof component and an endwall;

FIG. 36 is an elevation view of the system of FIG. 1;

FIG. 37 is a cross-sectional elevation view of the body of FIG. 3;

FIG. 38 is an elevation cross-section view of an airflow control system installed in a motor vehicle cab in operation;

FIG. 39 is an elevation cross-section view of an airflow control system installed in a motor vehicle cab in operation;

FIG. 40 is an elevation cross-section view of an airflow control system installed in a room of a building in operation;

FIG. 41 is an elevation cross-section view of the airflow control system of FIG. 40 in operation;

FIG. 42 is an elevation cross-section view of an airflow control system installed in an aircraft in operation;

FIG. 43 is an elevation cross-section view of an airflow control system installed in the dwelling area of a motorhome in operation;

FIG. 44 is an elevation cross-section view of the airflow control system of FIG. 43 in operation; and

FIG. 45 is an elevation cross-section view of the airflow control system of FIG. 43 in operation.

### DETAILED DESCRIPTION

Herein provided are a system and method for cultivating in a controlled environment. The method includes, and the system facilitates, providing consistent crosswise and downward airflow in a controlled cultivation environment, such as a sealed cultivation chamber.

Conditioned airflow is directed downwardly and in crosswise opposition into the sealed cultivation chamber. The airflow may be conditioned in terms of its relative humidity, temperature, CO₂ levels, or other factors relevant to plant growth. While travelling downwardly and crosswise through the chamber, the air tumbles through leaves, stems, flowers, fruits and other portions of plants growing in the chamber. Consistent airflow may provide benefits including morphological changes or other responses in the plants being cultivated. Conditioned airflow may provide other benefits, including temperature and humidity control, and CO₂ exchange with the plants. Sufficiently forceful airflow may provide benefits in terms of scrubbing the surfaces of the leaves, removing spores, viruses, bacteria and other infectious agents from the surfaces of the leaves and stems. Downward airflow scrubs the particles and material downward, pushing infectious agents to the floor. The conditioned airflow also transports CO₂ and cold air toward the plants, and humidity and heat away from the plants (in most cases; some plants may thrive on greater humidity and heat, in which case the conditioned air may be hot and humid rather than cool and dry), in addition to displacing spores, viruses, bacteria or other infectious particles from the plant surfaces.

The conditioned airflow tumbles through the plants, resulting in spent airflow. An intake proximate the bottom of the sealed cultivation chamber receives the spent airflow and the spent airflow is conditioned before again being directed downwardly and in crosswise opposition into the cultivation chamber. Conditioning includes filtration to remove particles and contaminants through a coarse particle filter. Conditioning may include application of a moisture droplet removal system, a heat exchanger, a humidifier, a desiccator, a chemical purification filter or other approaches to removing volatile or suspended organic compounds (e.g. activated carbon filter, carbon plate, activated charcoal filter, a HEPA filter etc.), or other conditioning equipment. CO₂ or an atmospheric gas blend may be added to the spent airflow as part of conditioning. Any cooling or addition of CO₂ may be added to the airflow above the point at which the conditioned airflow is directed into the chamber. Similarly, where humidity is to be added to the conditioned airflow, any humidity may also be added above the point at which the conditioned airflow is directed into the chamber. In each case, adding CO₂ or humidity, or cooling, is advantageously done above the point at which the conditioned airflow is directed into the chamber because each of these treatments increases the density of the conditioned airflow.

The crosswise nature of the airflow is balanced from left to right to avoid pushing the plants over, while still stressing xylem, which in turn stresses the plants and induces morphological changes. This may be provided by using one or more pairs of nozzles that point into the cultivation chamber from each of the cultivation chamber, and that point downwards at an angle converging on where the canopy is expected to be during cultivation. The nozzles may be adjustable during growth or fixed. Consistency may be facilitated by managing airflow such that airflow into the chamber through the nozzles and the diffusers, and the airflow out of the chamber through the intakes, are equal or substantially equal to each other, and within 20% in terms of volume over time. The greater the difference in volume, the more disruptive that the difference will be to even airflow. A volume of the spent airflow flowing into conditioning system may also be substantially equal to a volume of the conditioned airflow being reintroduced into the cultivation chamber, and within 20%. Airflow consistency within the chamber is also facilitated by tuning successive nozzles and diffusers with greater diameter orifices the further they are from the conditioning unit and source of airflow.

Some plants produce high humidity at their surface, creating a microclimate, trapping infrared radiation. The high local humidity and heat facilitate propagation of mildew and mold. Greenhouse fans are for disrupting stratification of heat, and not for dispersing humidity to protect the plants from mold. In contrast, the system and method herein described apply and provide a scrubbing action with airflow to remove infectious particles from the surface of the plants, reducing particle residence time and reducing the opportunity for infection. The method and system for controlling airflow may provide advantages in terms of power usage. In this case, the airflow may keep the plant surface cool, removing the need for an HVAC to offset heating by lamps.

Other features may be included in the sealed cultivation chamber to maintain cleanliness and facilitate turnover after a crop is harvested. A floor may be shaped with a sloped portion that periodically resets along the length of the chamber, for facilitating cleaning of the chamber by spraying. The periodic reset of the floor slope allows for modular construction of chambers of varying length while maintaining advantages of easy cleaning and draining. During cultivation, the sloped portion and the drain would be covered by floorboards to provide an even walking surface.

A spraying system may also be included to flood the chamber with disinfectant fluids following harvest and during preparation for a new harvest. An automated deluge sterilisation cycle may be applied through the spraying system after each harvest. When the deluge system is activated, cleaning fluid may be pumped, at pressure, into the grow chamber through large droplet fire suppression spray heads. The kinetic energy of the large droplets falling downward into the chamber moves loose waste materials and dust down into floor drains and out of the cultivation chamber. A cleaning fluid, such as bleach or Cl₂ at low concentration in water, or any suitable cleaning chemical in any suitable solvent, sanitizing and sterilizing surfaces in the cultivation chamber. Once the sterilization liquid cycle is completed, the conditioning system may increases the temperature to a temperature between the boiling point of the cleaning chemical and the solvent, such as about 80° C. at fifty percent humidity for evaporating Cl₂ from a solution of Cl₂ in water. The cleaning chemical then boils and becomes suspended in the cultivation chamber, allowing greater exposure to surface for sterilization. The conditioning system then cycles the atmosphere, drawing the gaseous cleaning chemical through the conditioning system, removing any remaining contaminants. As gaseous cleaning chemical flows through the plenum, UVC lights or other light sources may be included to react with the cleaning chemical, oxidizing and neutralizing Cl₂ or otherwise inactivating cleaning chemicals. This process leaves the cultivation chamber sterilized and ready for the next crop.

The method and system provided herein may also be applied in applications other than cultivation to provide airflow control in a chamber. Depending on the application, the other applications may be closed system, open system or selectable as between closed system and open system. The downward and crosswise airflow may be applied in any context where air quality, cleanliness and comfort of individuals in the chamber is important. The chamber may be in a building, motor vehicle cab, aircraft, motorhome dwelling area, kitchen, smoking lounge, vaping lounge, or any suitable chamber. The chamber may also include cultivation areas that are not sealed and for which airflow is recirculated without conditioning. Incoming airflow is directed downwardly and in crosswise opposition into the chamber. While travelling downwardly and crosswise through the chamber, the air pushes vapour, smoke or other particulates, pests, viruses or other infectious agents, odour or other airborne environmental features downward. The method and system may mitigate the presence of head-level carcinogens that result from smoking in an enclosed area by sweeping smoke to the floor.

The incoming airflow may be conditioned in terms of its relative humidity, temperature, oxygen saturation, CO₂ levels, or other factors relevant to the environment in the chamber. Conditioning may be applied to open and closed systems. The incoming airflow may include outgoing airflow that was conditioned prior to being reintroduced as incoming airflow. The conditioning system may be particularly useful in applications where odour, heat or particulates are to be removed, such as in rooms or vehicle cabs where smoking, vaping, cooking or other activities that result in particulates or volatiles being suspended or otherwise introduced into the air. Conditioning of the outgoing airflow may have particular effectiveness for applications directed to providing a safe environment for smoking or vaporizing cannabis, tobacco, other plants, plant extracts or manufactured vaporization solutions. In some applications, the airflow control system may be a closed system in which the airflow is conditioned and recycled. In other applications, the airflow control may be an open system without tightly controlled conditioning (e.g. heat exchange or humidity control only, etc.) or with no conditioning. The conditioning system may have particular application in motor vehicles and aircraft, which typically included climate control.

The crosswise nature of the airflow may be balanced from left to right to mitigate exposing people and objects in the chamber to a net airflow in one direction. The airflow scrubs surfaces, removing spores, viruses, bacteria and other infectious agents from the surfaces within the chamber. The downward motion of the airflow scrubs particles and material downward, pushing infectious agents to the floor. An intake proximate the bottom of the chamber receives spent airflow and the airflow may be provided to a conditioning system to provide incoming airflow before again being directed downwardly and in crosswise opposition into the chamber.

Where a conditioning system is applied, the conditioning system may include filtration to remove particles and contaminants through a coarse particle filter and may include a moisture droplet removal system, a charcoal filter, a HEPA filter, a heat exchanger, a humidifier, a desiccator, or other conditioning equipment. Fresh air, oxygen or an atmospheric gas blend may be added to the airflow. Any cooling or addition of gasses, liquids or particulates may be added to the airflow above the point at which the conditioned airflow is directed into the chamber.

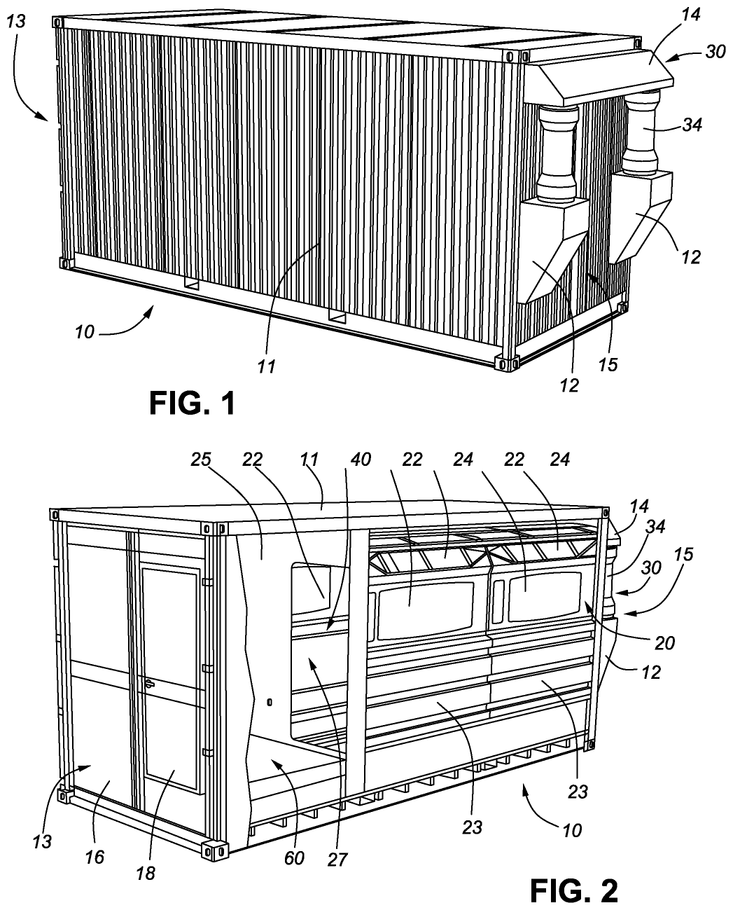

FIGS. 1 and 2 show a cultivation system 10. The cultivation system includes an outer shell 11 with a body 20 located inside the outer shell 11. The outer shell 11 is shown as a cargo container. The outer shell 11 extends between a first end 13 and a second end 15. The first end 13 includes a pair of wide access doors 16 and a personnel door 18. The second end 15 includes pre-conditioning ducting 12 and post-conditioning ducting 14 for a conditioning system 30. A cultivation chamber 40 is located within the body 20. An antechamber 60 is accessible from the wide access doors 16 and the personnel door 18. The cultivation chamber 40 is accessible from the antechamber 60. The outer shell 11 may include a weatherproof building skin, providing a conditioned atmosphere around the body 20 to protect the cultivation system 10 from the elements. The weatherproof building skin may be printed to blend in with or contrast with the surrounding environment.

The outer shell 11 may be reinforced and otherwise designed to accommodate stacking of the cultivation systems 10. Multiple examples of the cultivation system 10 may be stacked or positioned side-by-side to prepare a multi-level growing facility with independently isolated cultivation chambers 40 to contain and isolate disease or other causes of crop failure, mitigating the effects of these events on yield. Utilities such as power and water, and inputs such as nutrients and cleaning chemicals, may be centrally managed for distribution to multiple cultivation systems 10 connected with each other. In some cases, multiple cultivation systems 10 may have independent and local fertigation chemical storage tanks, with either centralized or per-unit management of fertigation. Similarly, growing conditions such as temperature, humidity and other factors may be controlled in a centralized or per-unit fashion for multiple cultivation systems 10. In addition, installations with multiple cultivation systems 10 may include similarly-shaped office, washroom, storage, utility, prep room and accommodation cubes in combination with the cultivation systems 10.

The antechamber 60 can be accessed from wide access doors 16 and the personnel door 18. The doorway 27 provides access between the antechamber 60 and the chamber 40. The cultivation chamber 40 may be overpressured to a first pressure, for example to 3 atmospheres above atmospheric pressure. The antechamber 60 may be overpressured to a second pressure that is lower than the first pressure and greater than atmospheric pressure, for example to 1 atmosphere above atmospheric pressure.

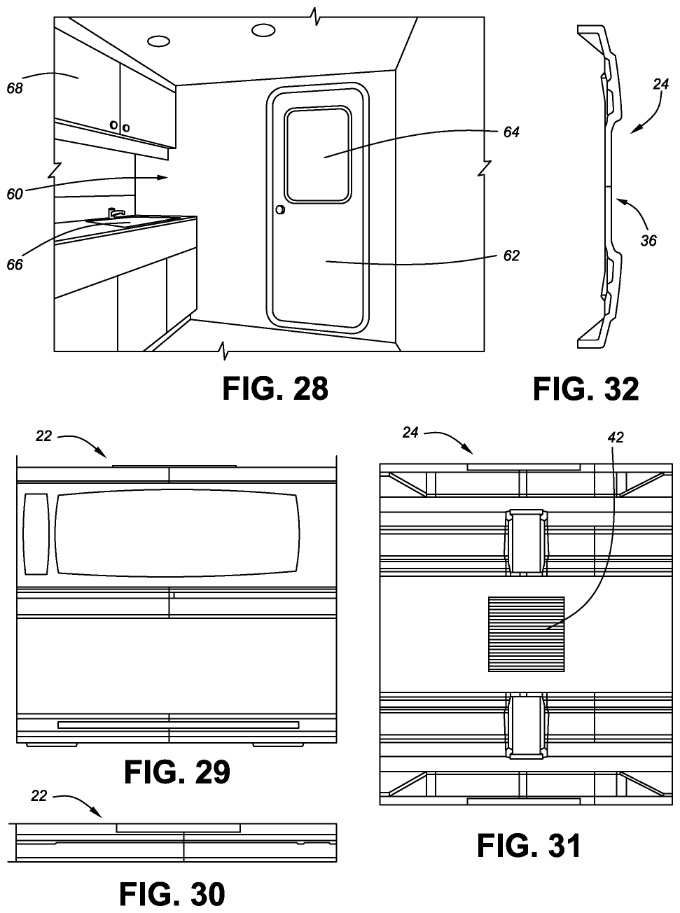

The antechamber 60 provides two-zone controlled access. The personnel door 18 and a door in the doorway 27 may include autonomous locking mechanisms that lock one of the personnel door 18 and a door in the doorway 27 where the other is opened. The locking feature mitigates the chances of contamination when personnel enter the cultivation chamber 40. Individuals may be cleared to access the antechamber 60 only, or to also access the cultivation chamber 40. For example, general cleaning and resupply staff could be cleared to enter the antechamber 60 but access to the cultivation chamber 40 can remain tightly controlled. The two-level control further mitigates contamination of the cultivation chamber 40 that would follow if both the personnel door 18 and the doorway 27 were opened. Cameras and a window 64 (see FIG. 28) reduce the need to enter and contaminate the crop, improving crop security.

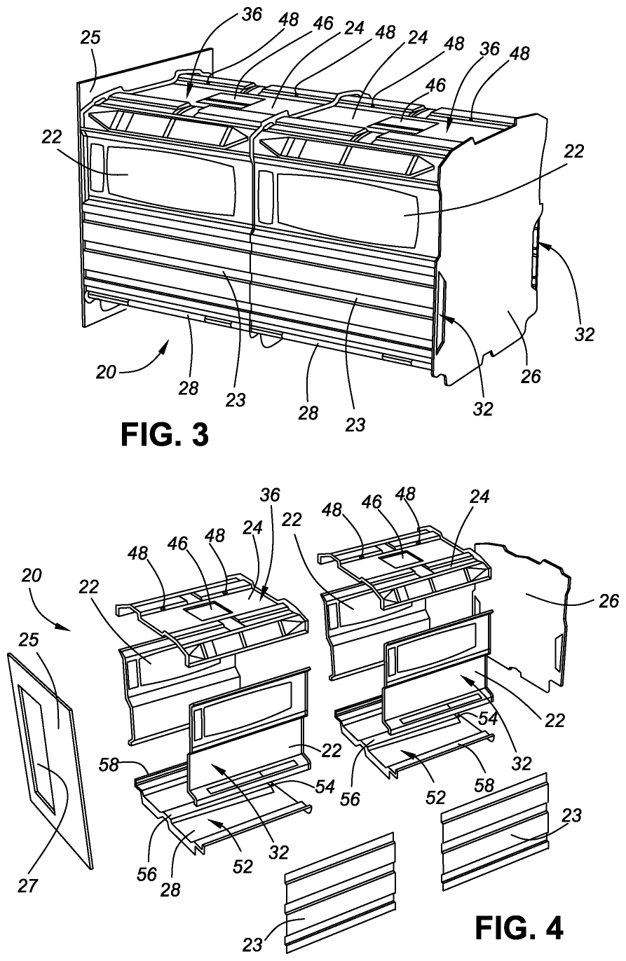

FIGS. 3 and 4 show the body 20. The body 20 includes four sidewalls 22. The sidewalls 22 are arranged in pairs. Each sidewall 22 includes a plenum panel 23 connected with and separated from the sidewall 22. A roof component 24 is connected with each pair of sidewalls 22. A first endwall 25 is located proximate the first end 13 and a second endwall 26 is located proximate the second end 15. A doorway 27 to the cultivation chamber 40 is defined within the first endwall 25 for providing access to the cultivation chamber 40.

The conditioning system 30 includes a pair of conditioning units 34 and airflow conduits between the conditioning units 34 and the cultivation chamber 40. The airflow conduits include a first plenum 32 and a second plenum 36. The first plenum 32 provides airflow communication between the cultivation chamber 40 and the conditioning units 34. The second plenum 36 provides airflow communication between the conditioning units 34 and the cultivation chamber 40. The first plenum 32 is defined within each of the sidewalls 22, and between the sidewall 22 and a removable plenum panel 23. The second plenum 36 is defined between the roof component 24 and the outer shell 11. The volume of the first plenum 32, combined between all sidewalls 22, is substantially equal to the volume within the second plenum 36, and within 20%. The distance between the roof components 24 and the outer shell 11, and the distance between the side walls 22 and the plenum panels 23, provides a variable for equalizing the combined volume within the first plenum 32 with the volume within the second plenum 36 and within 20%. The height of the first plenum 32 and the width of the second plenum 36 may also provide variables to equalize the combined volume within the first plenum 32 with the volume within the second plenum 36.

The conditioning units 34 may include water droplet removal systems, particulate filters (e.g. a foam filter, etc.), chemical purification filters other approaches to removing volatile or suspended organic compounds (e.g. activated carbon filter, carbon plate, activated charcoal filter, a HEPA filter etc.), humidity exchangers for increasing or decreasing humidity, heat exchangers for heating or cooling the airflow, or combinations of the foregoing. Cooling of the airflow, addition of humidity, and addition of CO₂ each take place in the second plenum 36, which is within the roof component 24 and above the cultivation chamber 40. The greater density of cool, humid and CO₂-laden air causes downward airflow into the cultivation chamber 40.

FIG. 5 shows the cultivation chamber 40. The body 20 includes an output for airflow into the cultivation chamber 40. The output includes a plurality of diffusers 42 and a plurality of pairs of nozzles 44 are present in the roof components 24 at an upper portion of the cultivation chamber 40, in this case in the roof components 28. The nozzles may also be defined in the sidewalls. A pair of electrical outlets 43 are present on the sidewalls 22. Light racks 41 are shown in FIGS. 36 and 37, but are removed from FIG. 5 so as not to obscure other features on the roof component 24. The sidewalls 22, roof components 24, floor components 28, first endwall 25 and second endwall 26 may be designed to facilitate effective light dispersion and photon utilization. High gloss white finish may be applied to push light energy back to the plants with minimal absorption, and contours may be designed to reflect light up and under the canopy.

The diffusers 42 and the nozzles 44 provide airflow of conditioned air to the cultivation chamber 40. An intake 45 is provided at a lower portion of the sidewalls 22 for receiving spent airflow that has passed through the cultivation chamber 40. The diffusers 42 and the nozzles 44 are located to provide downwardly directed crosswise airflow to tumble through plants in the cultivation chamber 40. The nozzles 44 being paired allows consistent and even airflow through the cultivation chamber 40. The nozzles 44 are angled to converge the airflow on the expected location of plants in the cultivation chamber 40 to continuously and consistently expose plants being cultivated to airflow at a frequency and with other properties selected by cultivators using the cultivation system 10. The nozzles 44 may be arranged in opposed 45 degree angles as shown, or in any pair of matched and horizontally opposed angles that will, in combination with downward airflow from the diffuser 42, converge the airflow on the plants. The nozzles 44 or the height of plants being cultivated may be adjustable to position the plants in the airflow during cultivation (see FIGS. 25 to 27).

As shown in FIG. 3, the diffuser 42 may be fed from the second plenum 36 at diffuser inputs 46. The nozzles 44 may be fed with conditioned airflow from the second plenum 36 at nozzle inputs 48. The diffuser inputs 46 and the nozzle inputs 48 are fed from the same airflow source—the second plenum 36. The diffusers 42 and the nozzles 44 are tuned with greater orifice sizes as the distance from the conditioning unit 34 becomes greater. Similarly the intake 45 is tuned to account for the varying distance from the conditioning unit 34 to take in spent airflow consistently across a length of the body 20.

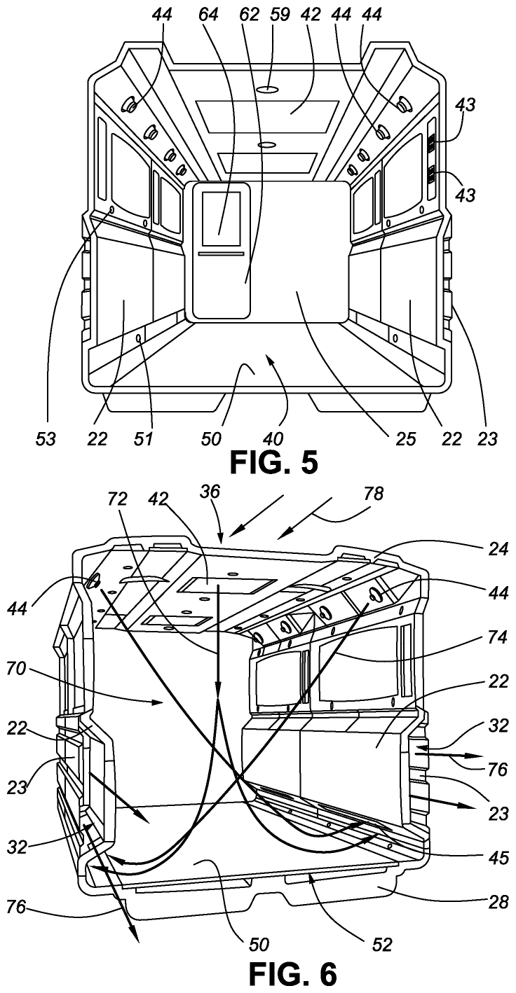

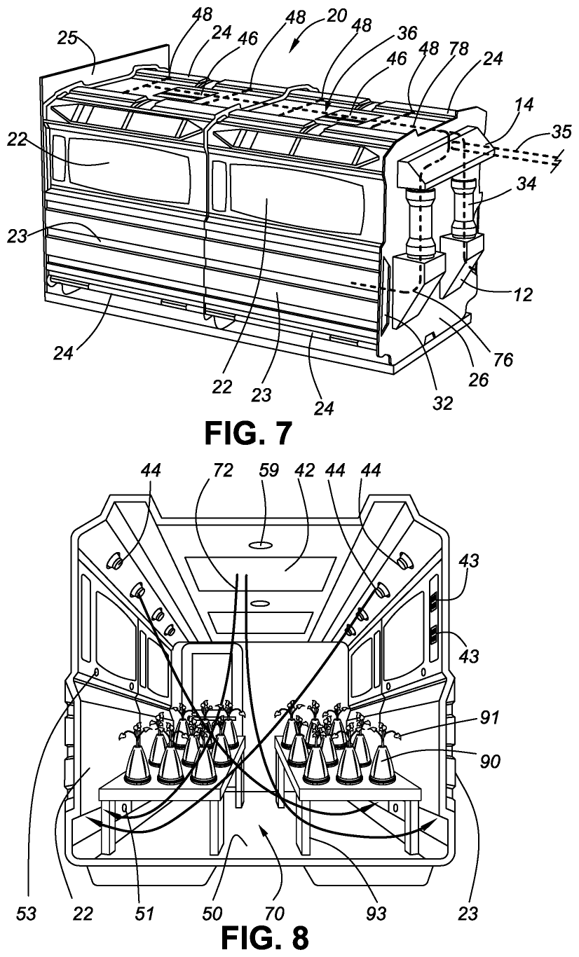

FIGS. 6 and 7 show the body 20 while in operation. The diffusers 42 and the nozzles 44 provide airflow 70 downwardly and in crosswise opposition into the cultivation chamber 40. The diffusers 42 provide downward airflow 72 in a vertically downward direction. The nozzles 44 provide angled airflow 74 downwardly at two angles that are substantially equal in their respective vertical components, the two angles being within 5° (as used at any point herein, meaning within any of 5, 4, 3, 2 or 1°) of each other, and opposed across a width of the cultivation chamber 40 in their respective horizontal components. The horizontal opposition of the first angle and the second angle across the width of the cultivation chamber 40 evens out the airflow 70 horizontally.

An input line 35 is in communication with the second plenum 36 for providing additional gas (e.g. CO₂, purified air, etc.), input particulate (e.g. nutrients, etc.), input liquid droplets (e.g. water with dissolved nutrients, etc.), or other input material to the growth chamber. The input line 35 is in airflow communication with the second plenum 36 at the post-conditioning ducting 14. The input line may also be in communication with the second plenum downstream of the post-conditioning ducting. The input line may be in airflow communication with the first plenum upstream of the conditioning units if a particular application allows for an advantage by conditioning the input material upstream of the conditioning units.

After the airflow 70 passes through the cultivation chamber 40, the airflow 70 enters the intakes 45. Spent airflow 76 flows through the first plenum 32 to the conditioning unit 34. The spent airflow 76 is conditioned by the conditioning unit 34 and conditioned airflow 78 flows into the second plenum 36 to be reintroduced into the cultivation chamber 40 by the diffusers 42 and the nozzles 44.

FIG. 8 shows a plurality of tapered vessels 90 located on a growing table 93. Each of the tapered vessels 90 includes a plant 91. The tapered vessels 90 are positioned to locate the plants 91 in the downward and crosswise opposed airflow 70. The airflow 70 can then scrub and exchange temperature, humidity, CO₂ or other chemicals with the plants 91 using the conditioned airflow 78, resulting in the spent airflow 76. The spent airflow 76 is passed through a closed system and conditioned for control over temperature, humidity, and CO₂ levels on the plants 91. Spores, viruses, bacteria or other infectious particles are swept downward and away from the plants, and sequestered by the conditioning unit 34. When a door 62 between the antechamber 60 and the cultivation chamber 40 (see FIG. 28) is opened or the cultivation chamber 40 is otherwise temporarily made an open system, additional gas, such as CO₂, can be added for distribution through the diffusers 42 and the nozzles 44, for example to the second plenum 36, which is above the diffuser inputs 46 and the nozzle inputs 48. Distribution of dense gasses such as CO₂ or cool air may be facilitated by gravity when the dense gasses are provided from a high point in the room.

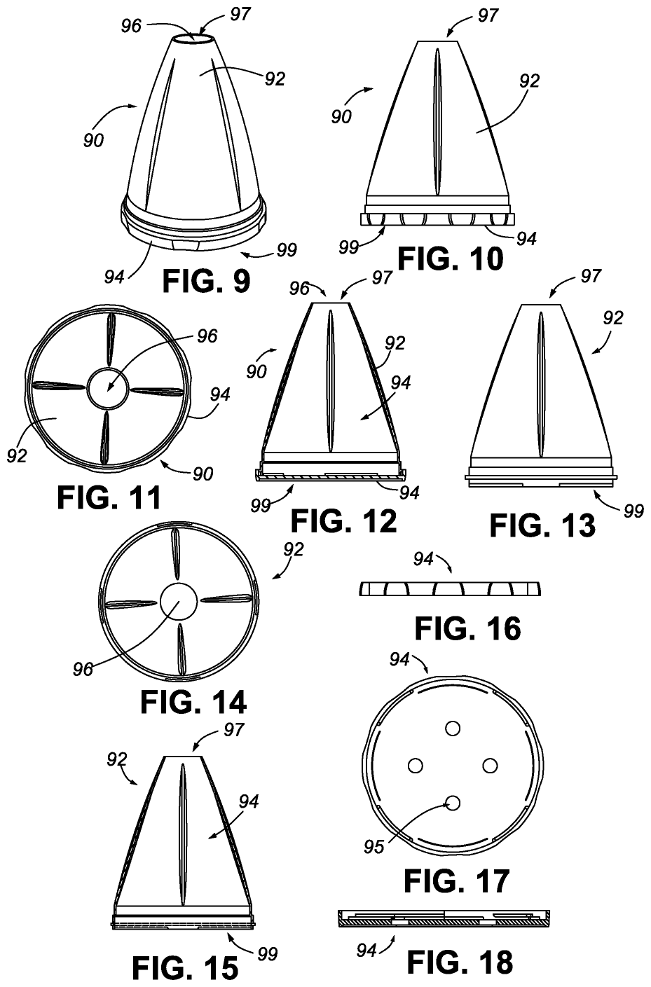

FIGS. 9 to 18 show the tapered vessel 90. The tapered vessel 90 includes a body 92 and a lid 94. The body 92 extends between a first end 97 and a second end 99. The body 92 includes an aperture 96 at the first end 97. The body 96 defines a cavity 98 within the body 96 for receiving grown media.

The aperture 96 is the narrowest point on the body 92 and may be sized to accommodate a plant stalk with minimal clearance around the plant stock. An input line for fertigation may be inserted through the aperture 96 to deliver nutrients to growth media in the cavity 98. The body could be designed to extend and taper beyond the aperture, locating the first end beyond the aperture and correspondingly locating the aperture proximate to the first end, and in which case the aperture would not be at the narrowest portion of the body.

The narrow dimensions of the aperture 96 mitigates spores, viruses, bacteria or other infectious particles from falling into the cavity and infecting growth media inside the body 92. The aperture 96 may be filled with a plug (e.g. silicone, etc.) to further mitigate infectious particles from falling into the body 92. The lid 94 includes a plurality of drains 95 from which to drain water and other fluids from the cavity 98.

The body 92 may be made of high heat capacity, insulative and brightly coloured material to mitigate wasteful heating up of growth media inside the body 92. The narrow aperture 96 and the high heat capacity of the body 92 also mitigate loss of moisture and heat from growth media in the cavity 98. Mitigation of moisture loss from growth media may facilitate maintaining moisture in the cavity 98 with a low relative humidity in the cultivation chamber 40. Similarly, mitigation of heat dissipation may facilitate maintaining temperature in the cavity 98 and a low temperature in the cultivation chamber 40.

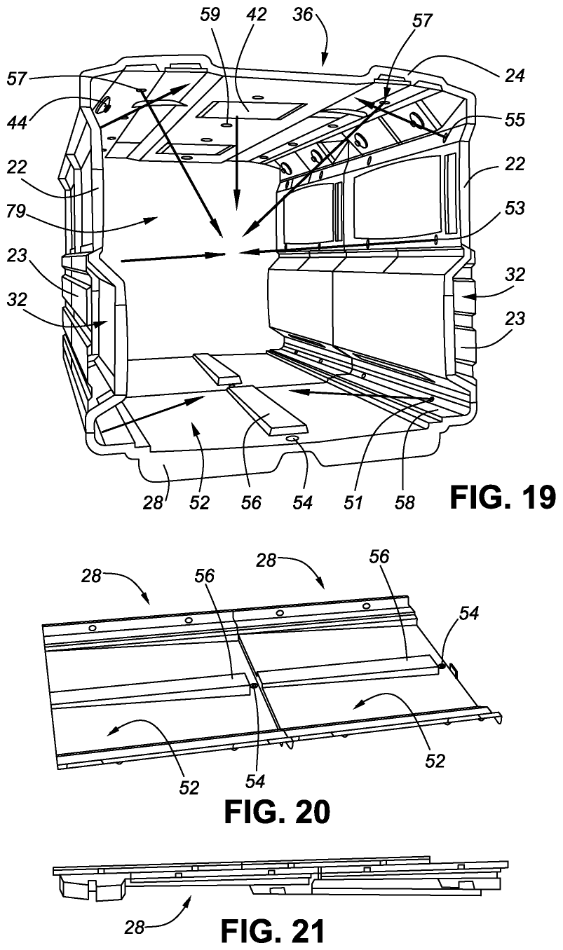

FIGS. 19 to 21 show a cleanout system for the cultivation chamber 40. When a crop has been harvested and it is time to clean out the cultivation chamber 40, a plurality of spray jets 51, 53, 55, 57 and 59 direct cleaning fluid 79 (e.g. H₂O₂, Cl₂, etc.) into the cultivation chamber 40. The intakes 45 are downward facing to mitigate entry of the cleaning fluid 79 into the intakes 45. The spray jets 51 are located a lower portion of the sidewall 22 below the intakes 45 and are angled upward. The spray jets 53 are located on an intermediate portion of each sidewall 22 and are angled perpendicular to the sidewall 22. The spray jets 55 are located on an upper portion of each sidewall 22 and are angled upward. The spray jets 57 are located on each roof component 24 and are angled downward. The spray jets 59 are located on each roof component 24 and point straight down.

The cleaning fluid 79 is provided under pressure into the chamber through the spray jets 51, 53, 55, 57 and 59. The pressure of the cleaning fluid 79 exiting the spray jets 51, 53, 55, 57 and 59 and bouncing off the floor components 28 and the sidewalls 22, may provide large droplets that fall and flow downward, resulting in a kinetic contribution to cleaning out the chamber 40. The cleaning fluid 79 may be water, and may include a cleaning chemical dissolved in the water (e.g. soap, Cl₂, H₂O₂, etc.). After the cleaning fluid 79 is provided to the chamber 40 and before draining the cleaning fluid 79, the chamber 40 may be heated to a temperature between the boiling point of a volatile cleaning chemical in the cleaning fluid 79 and the boiling point of the solvent in the cleaning fluid 79. The chamber 40 is then exposed to a gaseous cleaning chemical for maximum exposure of surfaces, plants and other objects located within the chamber 40.

The floor component 28 is shown during cleanout with a walkway panel 50 removed in FIGS. 19 to 21. Underneath the walkway panel 50 is a sloped portion 52 with a downward grade to a drain 54. The walkway panel 50 is removed in FIGS. 19 to 21, but when present rests on a central support 56 and on two lateral support 58. The height of the angled surface 52 opposite the drain 54, and the grade of the angled surface 52, each reset at the end of each floor component 24 to allow continual draining down the length of the body 20 while maintaining a consistent floor height.

The spray jets 51, 53, 55, 57 and 59 may also be used to destroy an infected crop while the plants 91 are still present in the body 20. In this case, the walkway panel 50 would remain in place on floor component 28. After treatment of the plants 91 with a disinfectant solution or appropriate spray, the plants 91 could be removed from the cultivation chamber 40 and transported for example through a facility that includes multiple cultivation systems 10 without significant likelihood of infecting other cultivation systems 10. With the dead plants 91 removed, the cleaning cycle without the walkway panel 50 could be repeated as shown in FIG. 19.

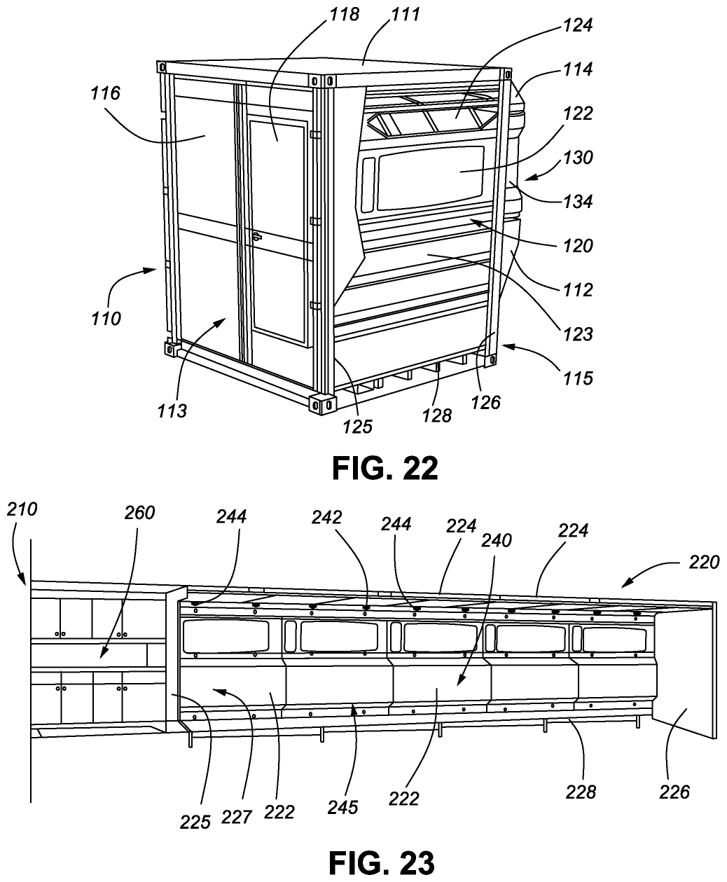

FIGS. 22 to 25 provide alternative examples of cultivation systems that illustrate the modular nature of the cultivation systems. In each of these systems, the power behind the conditioning system, and the tuning of the vents and diffusers (or other outputs), and of the intakes, may be calibrated to the greater or shorter length of the cultivation systems shown in FIGS. 22 to 25.

FIG. 22 shows a cultivation system 110. The cultivation system 110 includes the outer shell 111 with the body 120 located inside the outer shell 111. The outer shell 111 extends between the first end 113 and the second end 115. The first end 113 includes the pair of wide access doors 116 and the doorway 118. The second end 115 includes the pre-conditioning ducting 112 and the post-conditioning ducting 114 for the conditioning system 130, which includes the conditioning units 134. The body 120 includes two sidewalls 122 (one is not visible in FIG. 22, and is opposite the sidewall 122 that is shown) arranged in a pair. Each sidewall 122 includes the plenum panel 123 connected with and separated from the sidewall 122. The roof component 124 is connected with each of the sidewalls 122. The first endwall 125 is located proximate the first end 113 and the second endwall 126 is located proximate the second end 115. The first endwall 125 and the second endwall 126 are each connected with the sidewalls 122, the floor component 128 and the roof component 124.

In contrast with the system 10, the system 110 includes only one pair of sidewalls 122, and no antechamber. The sidewalls 122, roof component 124, first endwall 125, second endwall 126 and floor component 128 may be the same as the corresponding sidewalls 22, roof component 24, first endwall 125, second endwall 126 and floor component 28 of the system 10. The doorway 118 and wide access doors 116 provide access to the cultivation chamber within the body 120. The cultivation chamber may be overpressured to a first pressure, for example to 1 atmosphere above atmospheric pressure.

The cultivation system 110 also includes the internal airflow controls as shown for the system 10 in FIGS. 6 and 7. The cultivation chamber is defined inside the body 120. The nozzles are present in the cultivation chamber at an upper portion of the cultivation chamber, and the diffuser is present in the cultivation chamber in the roof component 124. The diffusers and the nozzles provide the airflow to the cultivation chamber. The intake is provided at a lower portion of the sidewalls 124 for receiving the airflow that has passed through the cultivation chamber. The diffuser and the nozzles are located to provide downwardly directed crosswise airflow into the cultivation chamber. The nozzles being paired allows consistent and even airflow through the cultivation chamber.

The nozzles are angled and situated relative to the diffuser to converge the airflow on a selected location in the cultivation chamber, such as toward plants being cultivated. The nozzles may be arranged in opposed 45 degree angles as shown, or in any pair of matched and horizontally opposed angles that will, in combination with the converge the airflow in the cultivation chamber. The nozzles may be adjustable to position the airflow on the plants being cultivated.

FIG. 23 shows a body 220 for a cultivation system 210. The body 220 includes ten sidewalls 222 (five are not visible in FIG. 22, and are opposite the sidewalls 222 that are shown) arranged in pairs. Each sidewall 222 includes the plenum panel (not shown) connected with and separated from the sidewall 222. The roof components 224 are connected with the corresponding sidewalls 222. The first endwall 225 and the second endwall 226 are each connected with one pair of the sidewalls 222, one of the floor components 228 and one of the roof components 224.

The sidewalls 222, roof components 224, first endwall 225, second endwall 226 and floor components 228 may be the same as the corresponding sidewalls 22, roof component 24, first endwall 25, second endwall 26 and floor component 28 of the system 10. The doorway 218 and wide access doors 216 provide access to the antechamber 260. The cultivation chamber 240 is accessible from the antechamber 260 through the door 262, and may be viewed from the antechamber 260 through a window 264. The cultivation chamber 240 may be overpressured to a first pressure, for example to 3 atmospheres above atmospheric pressure. The antechamber 260 may be overpressured to a second pressure that is lower than the first pressure and greater than atmospheric pressure, for example to 1 atmosphere above atmospheric pressure.

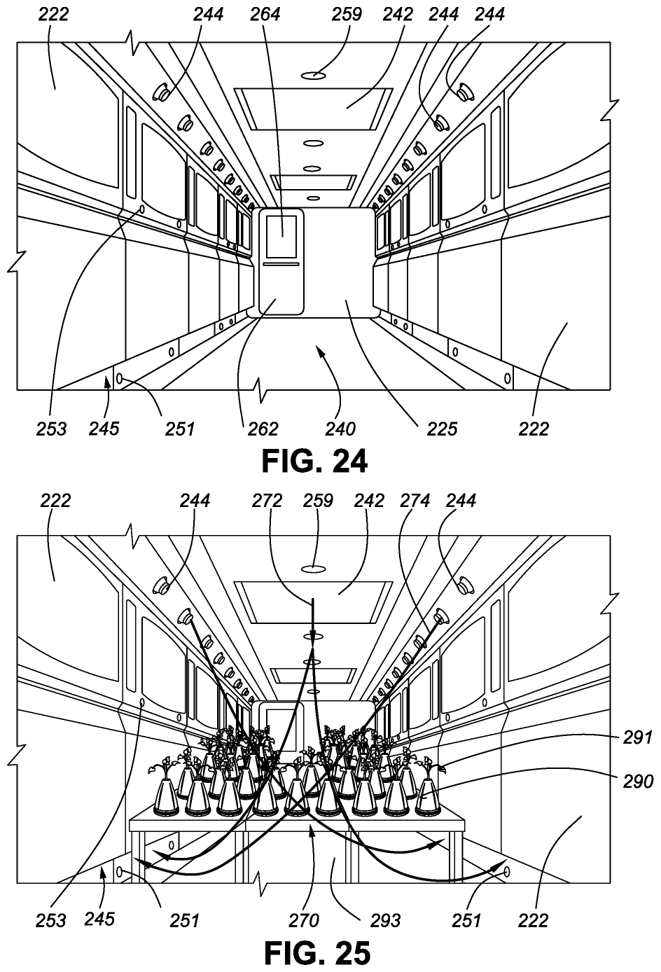

FIG. 24 shows the cultivation chamber 240. The nozzles 244 are present in the cultivation chamber 240 at an upper portion of the cultivation chamber 240, and the diffusers 242 are present in the roof component 224. The diffusers 242 and the nozzles 244 provide the airflow to the cultivation chamber 240. The intake is 245 provided at a lower portion of the sidewalls 224 for receiving the airflow that has passed through the cultivation chamber 240. The diffusers 242 and the nozzles 244 are located to provide downwardly directed crosswise airflow into the cultivation chamber 240. The nozzles 244 being paired allows consistent and even airflow 270 through the cultivation chamber 240.

The nozzles 244 are angled and situated relative to the diffuser 242 to converge the airflow 270 on a selected location in the cultivation chamber 240, such as toward plants being cultivated. The nozzles 244 may be arranged in opposed 45 degree angles as shown, or in any pair of matched and horizontally opposed angles that will, in combination with converging the airflow in the cultivation chamber 240. The nozzles 244 may be adjustable to position the airflow on the plants being cultivated. The cultivation chamber 240 also includes the spray jets 251, 253 and 259 for cleaning the cultivation chamber 240.

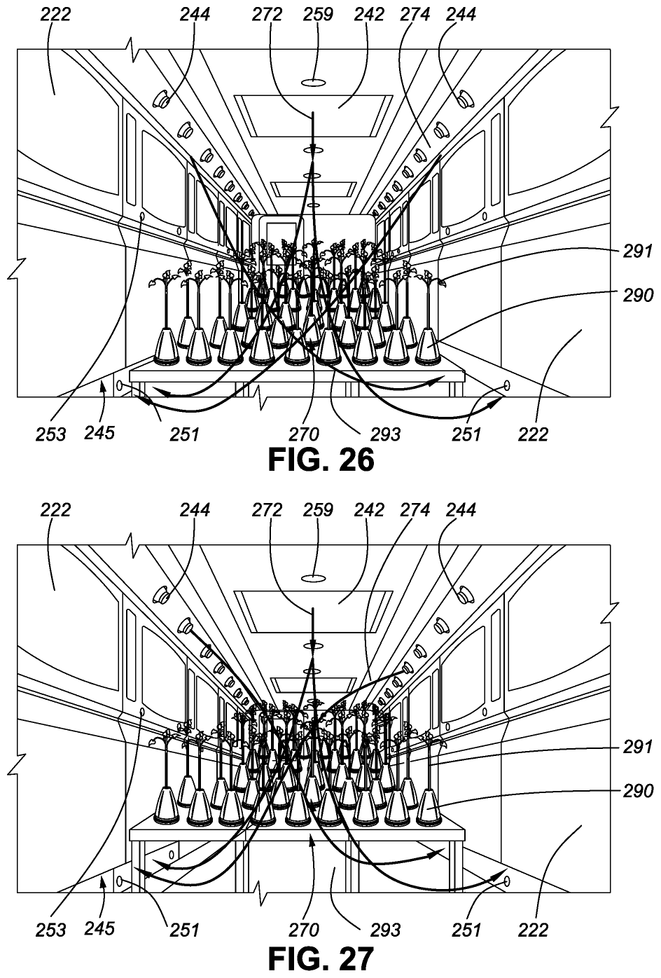

FIGS. 25 to 27 show plants 291 being cultivated inside the cultivation chamber 240. In FIG. 25, the plants 291 are young. In FIGS. 26 and 27, the plants 291 are more mature and consequently the distance between the plants 291 and ceiling lights (e.g. see light rack 41 in FIG. 36, which are omitted from FIGS. 25 to 27 for clarity to show the diffusers 242 and the jets 259). In addition, the mature plants 291 of FIGS. 26 and 27 will not be positioned within the airflow 270 in the same relative manner as the young plants 291 in FIG. 25 without adjusting the position of the plants 291 relative to the nozzles 244 and the diffusers 242.

FIG. 26 shows the table 293 at a lower elevation to maintain distance between the plants 291 and ceiling-mounted lights, and to maintain characteristics of the airflow 270 on the plants 291.

FIG. 27 shows the nozzles 244 adjusted to maintain characteristics of the airflow 270 on the plants 291. Adjusting the nozzles 244 does not affect the distance between the plants 291 and the ceiling lights. As a result, to maintain consistent exposure to ceiling lights, in addition to maintaining characteristics of the airflow 270 on the plants 291, the intensity or other properties of the ceiling lights would also be adjusted.

Returning to the system 10, FIG. 28 shows the antechamber 60 in detail. A doorway 62 to the cultivation chamber 40 includes the window 64 to allow quick visual inspection of the cultivation chamber 40. The window 64 may be prepared from materials that absorb external light to protect vegetative and production (e.g. flowering, etc.) grow cycles of any plants inside the cultivation chamber 40. A sink 66 and a set of cupboards 68 are also present in the antechamber 60. During night cycles when the cultivation lights are extinguished, only green lights may be activated in the cultivation chamber 40 or the antechamber 60 to avoid disrupting hormonal balances in the plants. In addition, when the cultivation chamber 40 or the antechamber 60 are occupied, a green alert light outside of cultivation system 10 may be activated, similar to a dark room, alerting anyone who may wish to enter to dim any ambient light in the area as much as possible.

The antechamber 60 includes a prep room and hand wash station for the cultivation system 10. The antechamber 60 may include an air curtain that activates when the personnel door 18 is closed to further clean employees as they enter the antechamber 60, regardless of whether the individual is cleared to enter the cultivation chamber. The air curtain may continue to operate for a short time (e.g. ten seconds) after personnel door 18 is closed to filter any remaining contaminants out of the air in the antechamber 60. The personnel door 18 and the door 62 may not be opened at the same time.

The cupboards 66 may include clean room consumables for compliance with standard operating procedures (hair and beard nets, gloves, sterile wipes for opening the personnel door 18, etc.). Water in the sink 66 may be conditioned and treated in the same as water supplied to the cultivation chamber 40 water to further mitigate the chances of contamination of the cultivation chamber 40.

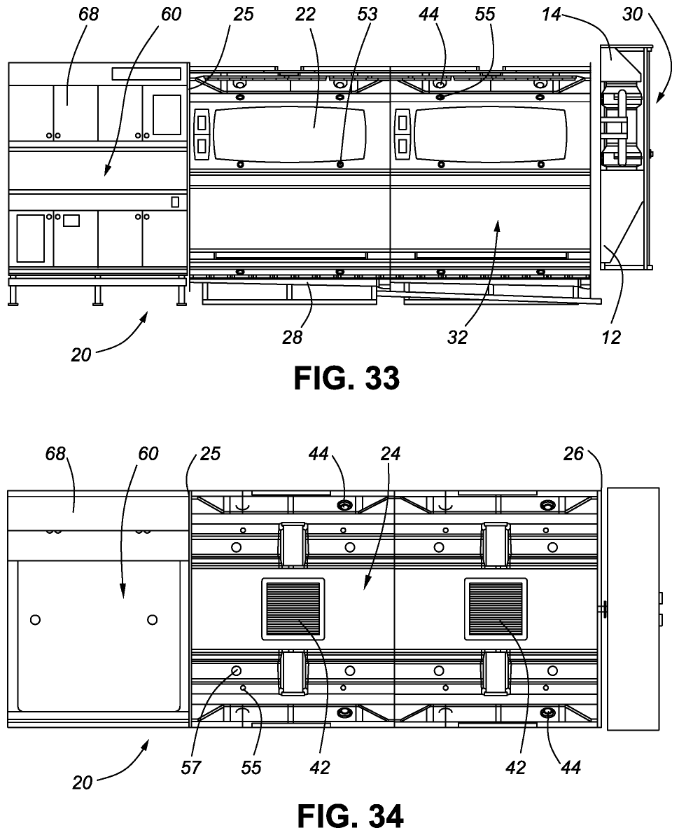

FIGS. 29 to 34 show details of the sidewall panels and roof components, both in isolation and as part of the body 20.

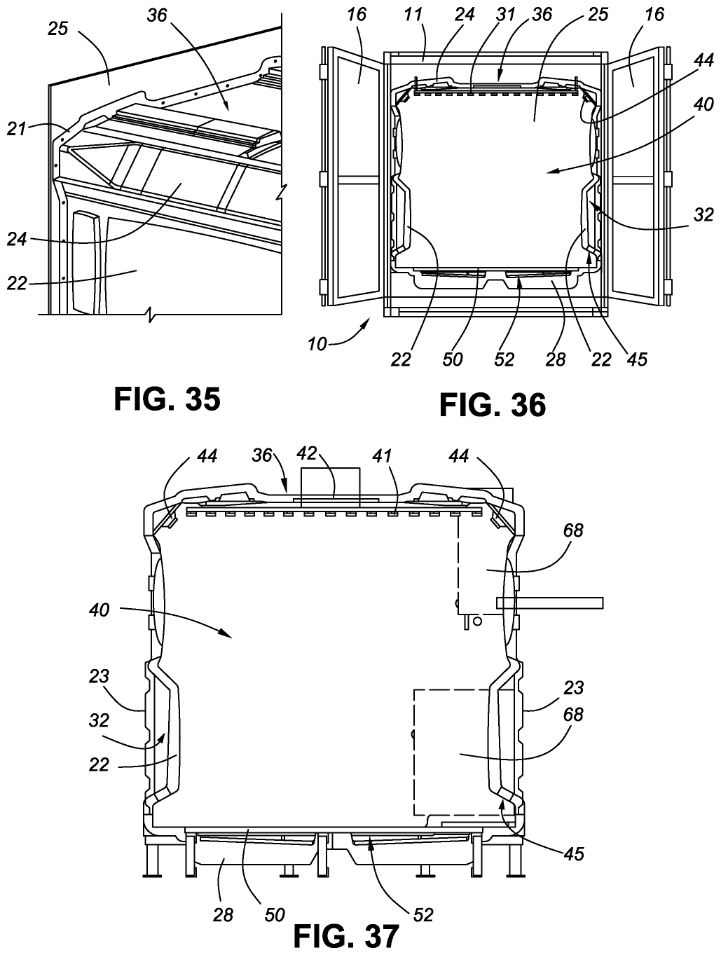

FIG. 35 shows flanged connections 21 extending outwardly from the body 20 that may be used to connect the sidewall 22 to the first endwall 25. Similarly, the flange connections 21 may also be used to connect sidewalls 22 together, sidewalls with the roof components 24, or sidewalls with the floor components 28. This approach to connecting modular components to each other may facilitate providing an inside surface of the cultivation chamber 40 with less pronounced seams or no seams between the sidewalls 22, between the sidewalls 22 and the roof components 24, between the first endwall 25 and one of the roof components 24, between the second endwall 26 and one of the roof components 24, between the first endwall 25 and one of the sidewalls 22, between the second endwall 26 and one of the sidewalls 22, and between the floor components 28 and the sidewalls 22.

FIG. 36 shows the body 20 located within the outer shell 11, as seen from the first end 13. The body 20 is shown in cross-section, illustrating the role of the outer shell 11 in defining the volume of the second plenum 36, and also showing the first plenum 32. A light rack 41 including grow lights to is also shown.

FIG. 37 shows the body 20 in cross section and the cultivation chamber 40 within the body 20. The cupboards 68 of the antechamber 60 are shown to illustrate the relative locations of the cupboards in relation to the cultivation chamber 40.

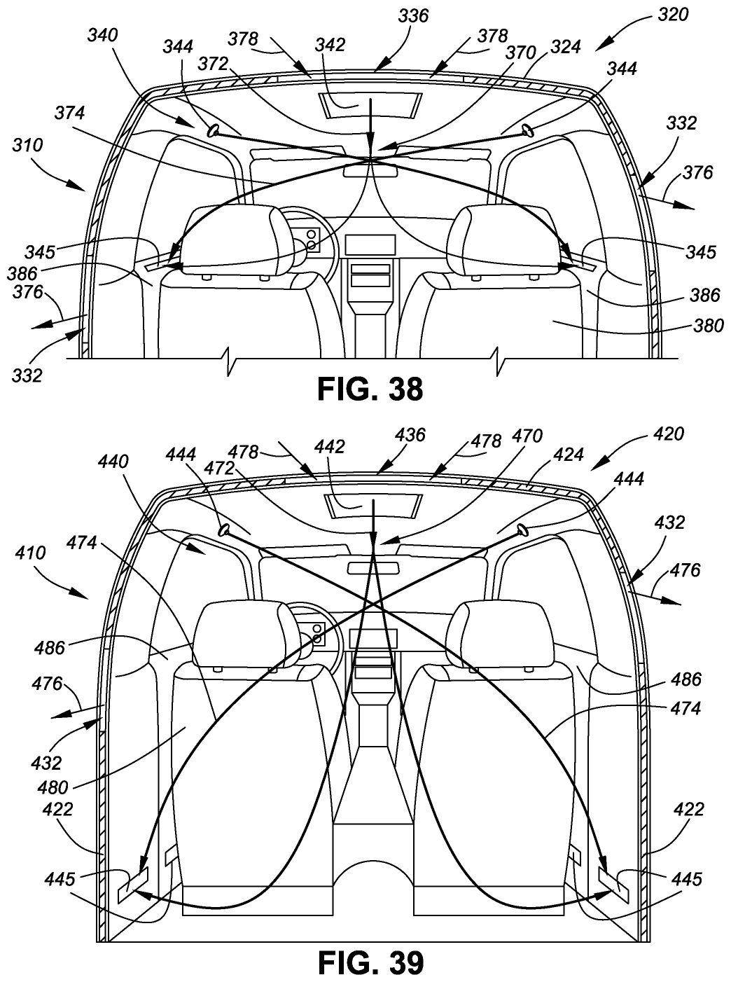

FIG. 38 is shows an airflow system 310 applied to a motor vehicle cab in operation. The airflow system 310 includes the body 320, which is defined by the motor vehicle body. The body 320 includes the sidewalls 322 and the roof component 324. The sidewalls 322 and the roof component 324 are integral or permanently connected with each other in forming the body 320, which is not modular (in contrast with the cultivation systems 10, 110 and 210). The sidewalls 322 and the roof component 324 include the airflow conduits. The first plenum 332 is defined within each of the sidewalls 322. The second plenum 336 is defined within the roof component 324. The first plenum 332 provides airflow communication between the chamber 340 and the second plenum 334.

The diffuser 342 and the nozzles 344 are present in the body 320 at an upper portion of the chamber 340 and proximate seats 380 and vehicle doors 386. The diffusers 342 and the nozzles 344 provide the airflow 370 to the chamber 340. The intake 345 is provided at medium portion of the sidewalls 322, in this case in the vehicle door 386 proximate a window of the vehicle door, for receiving the airflow 370 that has passed through the chamber 340. The diffuser 342 and the nozzles 344 are located to provide downwardly directed crosswise airflow into the chamber 340. The nozzles 344 being paired allows consistent and even airflow through the chamber 340.

The nozzles 344 are angled and situated relative to the diffuser 342 to converge the airflow 370 on a selected location in the chamber 340, such as toward passengers sitting in the seats 380. The nozzles 344 may be arranged in opposed 45 degree angles as shown, or in any pair of matched and horizontally opposed angles that will, in combination with the converge the airflow in the chamber 340. The nozzles 344 may be adjustable to position the airflow as desired by a user of the airflow system 310.

The nozzles 344 and the diffuser 342 are fed with the incoming airflow 378 from the second plenum 336. The diffuser 342 and the nozzles 344 provide the airflow 370 downwardly and in crosswise opposition into the chamber 340. The diffuser 342 provides the downward airflow 372 in a vertically downward direction. The nozzles 344 provide the angled airflow 374 at two angles that are substantially equal in their respective vertical components, and opposed across a width of the chamber 340 in their respective horizontal components. The horizontal opposition of the first angle and the second angle across the width of the chamber 340 evens out the airflow 370 horizontally.

The system 310 includes an airflow source, which is not shown in FIG. 38 for clarity of the other features in FIG. 38. The airflow source in airflow communication with the second plenum 336 for providing the incoming airflow 378. After the airflow 370 passes through the chamber 340, the airflow 370 enters the intakes 345.

The airflow source may be in airflow communication with the first plenum 332 for receiving the outgoing airflow 376 to be recirculated as incoming airflow 378 in a closed system. The outgoing airflow 376 flows through the first plenum 332 to the second plenum 336 and the incoming airflow 378 flows through the second plenum 336 to be reintroduced into the chamber 340 by the diffuser 342 and the nozzles 344. Alternatively, The outgoing airflow 376 may be vented externally and expelled from the motor vehicle, in which case the incoming airflow 378 may be sourced from externally to the motor vehicle in an open system. Each of these approaches to the outgoing airflow 376 may be applied in the same system with selectable changes in the airflow path allowing selection of open or closed loop systems.

In addition to the airflow source, the system 310 may include a conditioning system in airflow communication with the first plenum 332 and the second plenum 336. FIG. 38 does not show the conditioning units, which may be optionally included. Motor vehicles typically include climate control and the onboard climate control may play the role of the conditioning units.

Where the conditioning units are applied to the airflow system 310 that is a closed system, the first plenum 332 provides airflow communication between the chamber 340 and the conditioning units, and the second plenum 336 provides airflow communication between the conditioning units and the chamber 340. Where the conditioning units are applied to the airflow system 310, the volume of the first plenum 332 is equal to the volume within the second plenum 336. The cross-sectional area of the first plenum 332 within the sidewalls 322, and the cross-sectional area of the second plenum 336 within the roof component 324 provide variables to equalize the volume of the first plenum 332 with the volume within the second plenum 336.

The conditioning units may include water droplet removal systems, particulate filters (e.g. a foam filter, etc.), chemical purification filters other approaches to removing volatile or suspended organic compounds (e.g. activated carbon filter, carbon plate, activated charcoal filter, a HEPA filter etc.), humidity exchangers for increasing or decreasing humidity, heat exchangers for heating or cooling the airflow, or combinations of the foregoing. Cooling or heating of the airflow, addition of humidity and other conditioning takes place downstream of the conditioning units in the second plenum 336.

FIG. 39 is an airflow system 410 applied to a motor vehicle cab in operation. The airflow system 410 includes the body 420, which is defined by the motor vehicle body. The body 420 includes the sidewalls 422 and the roof component 424. The sidewalls 422 and the roof component 424 are integral with each other in forming the body 420, which is not modular (in contrast with the cultivation systems 10, 110 and 210). The sidewalls 422 and the roof component 424 include the airflow conduits. The first plenum 432 is defined within each of the sidewalls 422. The second plenum 436 is defined within the roof component 424. The first plenum 432 provides airflow communication between the chamber 440 and the second plenum 434.

The diffuser 442 and the nozzles 444 are present in the body 420 at an upper portion of the chamber 440 and proximate seats 480 and the vehicle doors 486. The diffusers 442 and the nozzles 444 provide the airflow 470 to the chamber 440. The intake 445 is provided at lower portion of the sidewalls 422, in this case proximate the bottom of the vehicle door 486, for receiving the airflow 470 that has passed through the chamber 440, in contrast with the intake 345, which is at a middle portion of the vehicle door 486. The diffuser 442 and the nozzles 444 are located to provide downwardly directed crosswise airflow into the chamber 440. The nozzles 444 being paired allows consistent and even airflow through the chamber 440.

The nozzles 444 are angled and situated relative to the diffuser 442 to converge the airflow 470 on a selected location in the chamber 440, such as toward passengers sitting in the seats 480. The nozzles 444 may be arranged in opposed 45 degree angles as shown, or in any pair of matched and horizontally opposed angles that will, in combination with the converge the airflow in the chamber 440. The nozzles 444 may be adjustable to position the airflow as desired by a user of the airflow system 410.

The nozzles 444 and the diffuser 442 are fed with the incoming airflow 478 from the second plenum 436. The diffuser 442 and the nozzles 444 provide the airflow 470 downwardly and in crosswise opposition into the chamber 440. The diffuser 442 provides the downward airflow 472 in a vertically downward direction. The nozzles 444 provide the angled airflow 474 at two angles that are substantially equal in their respective vertical components, and opposed across a width of the chamber 440 in their respective horizontal components. The horizontal opposition of the first angle and the second angle across the width of the chamber 440 evens out the airflow 470 horizontally.

The system 410 includes an airflow source, which is not shown in FIG. 39 for clarity of the other features in FIG. 39. The airflow source in airflow communication with the second plenum 436 for providing the incoming airflow 478. After the airflow 470 passes through the chamber 440, the airflow 470 enters the intakes 445.

The airflow source may be in airflow communication with the first plenum 432 for receiving the outgoing airflow 476 to be recirculated as incoming airflow 478 in a closed system. The outgoing airflow 476 flows through the first plenum 432 to the second plenum 436 and the incoming airflow 478 flows through the second plenum 436 to be reintroduced into the chamber 440 by the diffuser 442 and the nozzles 444. Alternatively, The outgoing airflow 476 may be vented externally and expelled from the motor vehicle, in which case the incoming airflow 478 may be sourced from externally to the motor vehicle in an open system. Each of these approaches to the outgoing airflow 476 may be applied in the same system with selectable changes in the airflow path allowing selection of open or closed loop systems.

In addition to the airflow source, the system 410 may include a conditioning system in airflow communication with the first plenum 432 and the second plenum 436. FIG. 39 does not show the conditioning units, which may be optionally included. Motor vehicles typically include climate control and the onboard climate control may play the role of the conditioning units.

Conditioning units may be used with the system 410. FIG. 39 does not show the conditioning units, which may be optionally included. Motor vehicles typically include climate control and the onboard climate control may play the role of the conditioning units.

Where the conditioning units are applied to the airflow system 410 that is a closed system, the first plenum 432 provides airflow communication between the chamber 440 and the conditioning units, and the second plenum 436 provides airflow communication between the conditioning units and the chamber 440. Where the conditioning units are applied to the airflow system 410, the volume of the first plenum 432 is equal to the volume within the second plenum 436. The cross-sectional area of the first plenum 432 within the sidewalls 422, and the cross-sectional area of the second plenum 436 within the roof component 424 provide variables to equalize the volume of the first plenum 432 with the volume within the second plenum 436.

The conditioning units may include water droplet removal systems, particulate filters (e.g. a foam filter, etc.), chemical purification filters other approaches to removing volatile or suspended organic compounds (e.g. activated carbon filter, carbon plate, activated charcoal filter, a HEPA filter etc.), humidity exchangers for increasing or decreasing humidity, heat exchangers for heating or cooling the airflow, or combinations of the foregoing. Cooling or heating of the airflow, addition of humidity and other conditioning takes place downstream of the conditioning units in the second plenum 436.

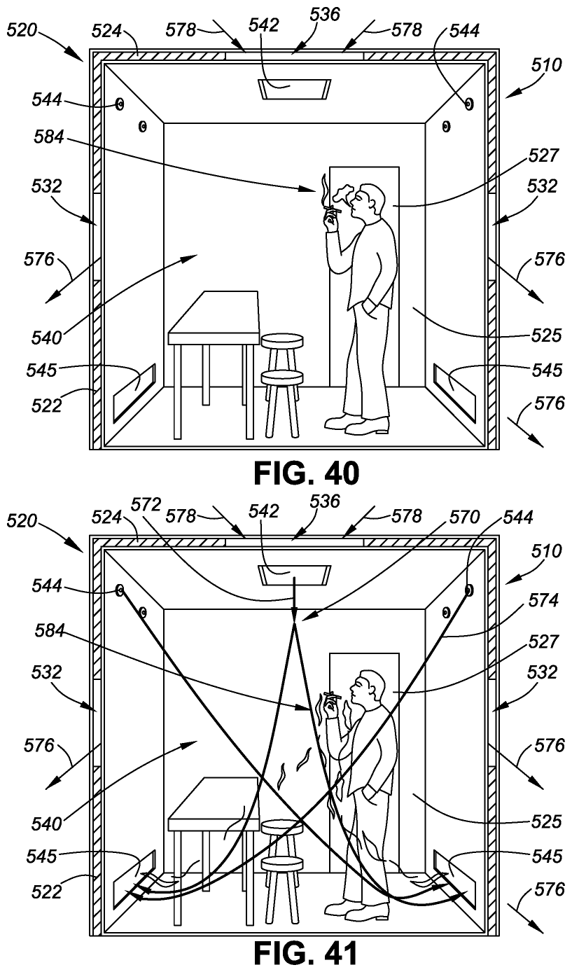

FIG. 40 shows an airflow system 510 applied to a room in a building. The airflow system 510 includes the body 520, which is defined by the portion of the building defining the room. The body 520 includes the sidewalls 522 and the roof component 524. The sidewalls 522 and the roof component 524 are integral with each other in forming the body 520, which is not modular (in contrast with the cultivation systems 10, 110 and 210). The sidewalls 522 and the roof component 524 include the airflow conduits. The first plenum 532 is defined within each of the sidewalls 522. The second plenum 536 is defined within the roof component 524. The first plenum 532 provides airflow communication between the chamber 540 and the second plenum 534.

The diffuser 542 and the nozzles 544 are present in the body 520 at an upper portion of the chamber 540. The diffusers 542 and the nozzles 544 provide the airflow 570 to the chamber 540. The intake 545 is provided at a lower portion of the sidewalls 522 for receiving the airflow 570 that has passed through the chamber 540. The diffuser 542 and the nozzles 544 are located to provide downwardly directed crosswise airflow into the chamber 540. The nozzles 544 being paired allows consistent and even airflow through the chamber 540.

The nozzles 544 are angled and situated relative to the diffuser 542 to converge the airflow 570 (see FIG. 41) on a selected location in the chamber 540, such as toward average head or shoulder level for an adult standing in the chamber 540. The nozzles 544 may be arranged in opposed 45 degree angles as shown, or in any pair of matched and horizontally opposed angles that will, in combination with the converge the airflow in the chamber 540. The nozzles 544 may be adjustable to position the airflow as desired by a user of the airflow system 510.

FIG. 41 shows the system 510 in operation. The nozzles 544 and the diffuser 542 are fed with the incoming airflow 578 from the second plenum 536. The diffuser 542 and the nozzles 544 provide the airflow 570 downwardly and in crosswise opposition into the chamber 540. The diffuser 542 provides the downward airflow 572 in a vertically downward direction. The nozzles 544 provide the angled airflow 574 at two angles that are substantially equal in their respective vertical components, and opposed across a width of the chamber 540 in their respective horizontal components. The horizontal opposition of the first angle and the second angle across the width of the chamber 540 evens out the airflow 570 horizontally.

The system 510 includes an airflow source, which is not shown in FIGS. 40 and 41 for clarity of the other features in FIGS. 40 and 41. The airflow source in airflow communication with the second plenum 536 for providing the incoming airflow 578. After the airflow 570 passes through the chamber 540, the airflow 570 enters the intakes 545.

The airflow source may be in airflow communication with the first plenum 532 for receiving the outgoing airflow 576 to be recirculated as incoming airflow 578 in a closed system. The outgoing airflow 576 flows through the first plenum 532 to the second plenum 536 and the incoming airflow 578 flows through the second plenum 536 to be reintroduced into the chamber 540 by the diffuser 542 and the nozzles 544. Alternatively, The outgoing airflow 576 may be vented externally and expelled from the building or sequestered, in which case the incoming airflow 578 may be sourced from externally to the building, or otherwise outside of any contact with the first plenum 532, in an open system. Each of these approaches to the outgoing airflow 576 may be applied in the same system with selectable changes in the airflow path allowing selection of open or closed loop systems.

In addition to the airflow source, the system 510 may include a conditioning system in airflow communication with the first plenum 532 and the second plenum 536. FIGS. 40 and 41 does not show the conditioning units, which may be optionally included. Motor vehicles typically include climate control and the onboard climate control may play the role of the conditioning units.

The system 510 may facilitate providing an area for smoking or vaping while mitigating the presence of head-level carcinogens and other undesirable components of smoke 584. The airflow 570 blows the smoke 584 into the intakes 545 and away from average head level of adults, who may be present in the chamber 540 and in the presence of the smoke 584.

Conditioning units may be used with the system 510. FIGS. 40 and 41 do not show the conditioning units, which may be optionally included and in a room that is a public place but allows smoking or vaping, are very likely to be included for compliance with regulations in most jurisdictions requiring filtration and purification of air, in addition to elimination of head-level carcinogens, in any kind of closed system for this application. Alternatively, the outgoing airflow 576 may be expelled from the building and the incoming airflow 578 may be sourced from within the building but exterior to the chamber 540, or from externally to the building, in an open system.

Where the conditioning units are applied to the airflow system 510 that is a closed system, the first plenum 532 provides airflow communication between the chamber 540 and the conditioning units, and the second plenum 536 provides airflow communication between the conditioning units and the chamber 540. Where the conditioning units are applied to the airflow system 510, the volume of the first plenum 532 is equal to the volume within the second plenum 536. The cross-sectional area of the first plenum 532 within the sidewalls 522, and the cross-sectional area of the second plenum 536 within the roof component 524 provide variables to equalize the volume of the first plenum 532 with the volume within the second plenum 536.

The conditioning units may include water droplet removal systems, particulate filters (e.g. a foam filter, etc.), chemical purification filters other approaches to removing volatile or suspended organic compounds (e.g. activated carbon filter, carbon plate, activated charcoal filter, a HEPA filter etc.), humidity exchangers for increasing or decreasing humidity, heat exchangers for heating or cooling the airflow, or combinations of the foregoing. Cooling or heating of the airflow, addition of humidity and other conditioning takes place downstream of the conditioning units in the second plenum $36.

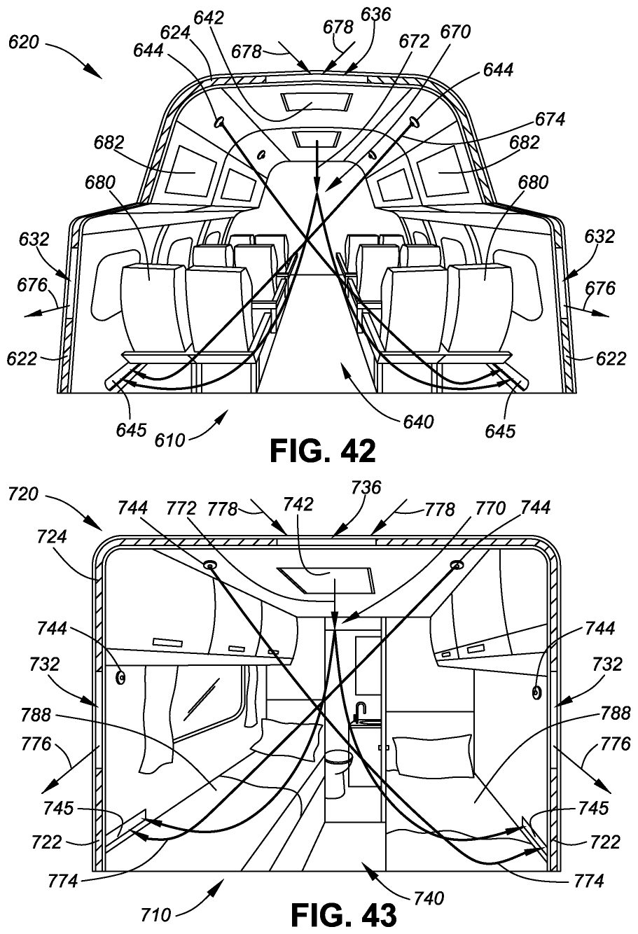

FIG. 42 is an elevation cross-section view of an airflow control system 610 installed in a passenger aircraft in operation. The airflow system 610 includes the body 620, which is defined by the aircraft body. The body 620 includes the sidewalls 622 and the roof component 624. The sidewalls 622 and the roof component 624 are integral with each other in forming the body 620, which is not modular (in contrast with the cultivation systems 10, 110 and 210). The sidewalls 622 and the roof component 624 include the airflow conduits. The first plenum 632 is defined within each of the sidewalls 622. The second plenum 636 is defined within the roof component 624. The first plenum 632 provides airflow communication between the chamber 640 and the second plenum 634.

The diffuser 642 and the nozzles 644 are present in the body 620 at an upper portion of the chamber 640 and proximate storage bins 682. The diffusers 642 and the nozzles 644 provide the airflow 670 to the chamber 640. The intake 645 is provided at a lower portion of the sidewalls 622 for receiving the airflow 670 that has passed through the chamber 640. The diffuser 642 and the nozzles 644 are located to provide downwardly directed crosswise airflow into the chamber 640. The nozzles 644 being paired allows consistent and even airflow through the chamber 640.

The nozzles 644 are angled and situated relative to the diffuser 642 to converge the airflow 670 on a selected location in the chamber 640, such as toward the seats 680. The nozzles 644 may be arranged in opposed 45 degree angles as shown, or in any pair of matched and horizontally opposed angles that will, in combination with the converge the airflow in the chamber 640. The nozzles 644 may be adjustable to position the airflow as desired by a user of the airflow system 610.

The nozzles 644 and the diffuser 642 are fed with the incoming airflow 678 from the second plenum 636. The diffuser 642 and the nozzles 644 may be tuned with greater orifice sizes as the distance from the conditioning unit or other source of the incoming airflow 678 becomes greater to maintain consistent airflow 670 along the length of the body 620. Similarly the intake 645 is tuned to account for the varying distance from the conditioning unit or other source of the incoming airflow 678 to take in the outgoing airflow 676 consistently across a length of the body 620.

The diffuser 642 and the nozzles 644 provide the airflow 670 downwardly and in crosswise opposition into the chamber 640. The diffuser 642 provides the downward airflow 672 in a vertically downward direction. The nozzles 644 provide the angled airflow 674 at two angles that are substantially equal in their respective vertical components, and opposed across a width of the chamber 640 in their respective horizontal components. The horizontal opposition of the first angle and the second angle across the width of the chamber 640 evens out the airflow 670 horizontally.

After the airflow 670 passes through the chamber 640, the airflow 670 enters the intakes 645. The outgoing airflow 676 flows through the first plenum 632 to the second plenum 636 and the incoming airflow 678 flows through the second plenum 636 to be reintroduced into the chamber 640 by the diffuser 642 and the nozzles 644. In contrast with the airflow systems 310, 410, 510 and 710, the closed system 610 for an aircraft is very likely to be a closed system due to regulatory requirements in most jurisdictions.

Conditioning units may be used with the system 610. FIG. 42 does not show the conditioning units, which may be optionally included, and in an aircraft are very likely to be included for compliance with regulations in most jurisdictions. Aircraft typically include climate control and the onboard climate control may play the role of the conditioning units.

Where the conditioning units are applied to the airflow system 610, the first plenum 632 provides airflow communication between the chamber 640 and the conditioning units, and the second plenum 636 provides airflow communication between the conditioning units and the chamber 640. Where the conditioning units are applied to the airflow system 610, the volume of the first plenum 632 is equal to the volume within the second plenum 636. The cross-sectional area of the first plenum 632 within the sidewalls 622, and the cross-sectional area of the second plenum 636 within the roof component 624 provide variables to equalize the volume of the first plenum 632 with the volume within the second plenum 636.

The conditioning units may include water droplet removal systems, particulate filters (e.g. a foam filter, etc.), chemical purification filters other approaches to removing volatile or suspended organic compounds (e.g. activated carbon filter, carbon plate, activated charcoal filter, a HEPA filter etc.), humidity exchangers for increasing or decreasing humidity, heat exchangers for heating or cooling the airflow, or combinations of the foregoing. Cooling or heating of the airflow, addition of humidity and other conditioning takes place downstream of the conditioning units in the second plenum 636.

FIGS. 43 to 45 show an airflow system 710 applied to the dwelling area of a motorhome in operation. The airflow system 710 includes the body 720, which is defined by the motorhome. The body 720 includes the sidewalls 722 and the roof component 724. The sidewalls 722 and the roof component 724 are integral with each other in forming the body 720, which is not modular (in contrast with the cultivation systems 10, 110 and 210). The sidewalls 722 and the roof component 724 include the airflow conduits. The first plenum 732 is defined within each of the sidewalls 722. The second plenum 736 is defined within the roof component 724. The first plenum 732 provides airflow communication between the chamber 740 and the second plenum 734.

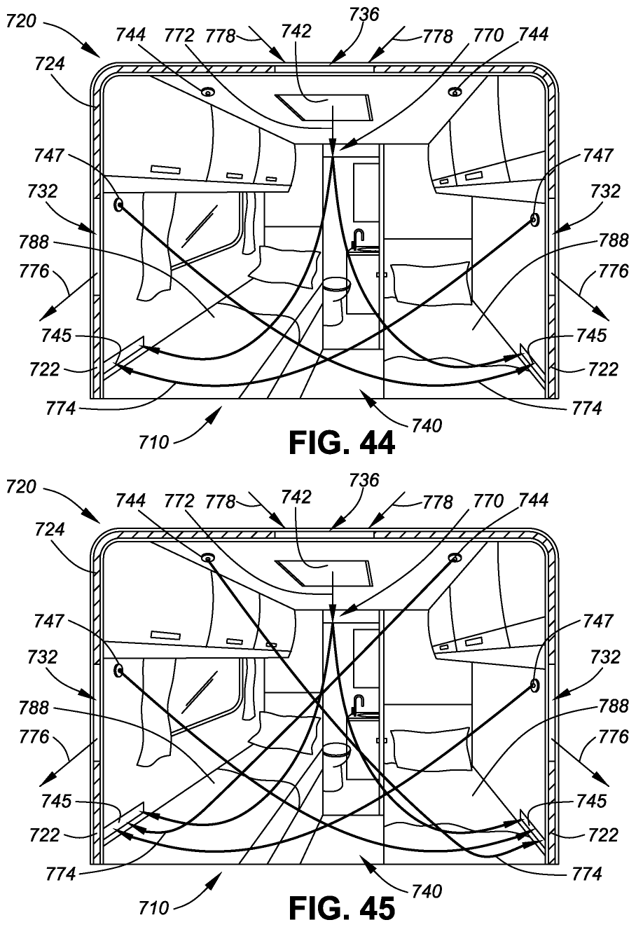

The diffuser 742 is located in the roof component 724. The nozzles 744 are present in the body 720 at an upper portion of the chamber 740 above and proximate to the storage bins 782. Lower nozzles 747 are positioned below the storage bins 782. The airflow 770 may be provided by the nozzles 744 above the storage bins 782 only, by the lower nozzles 747 (FIG. 44) below the storage bins 782 only, or by both the nozzles 744 and the lower nozzles 747 (FIG. 45). Use of the nozzles 744, the lower nozzles 747 or both may be selected based on the occupancy of the chamber 740 and whether occupants are on the beds 780 or elsewhere in the chamber 740. The diffusers 742, the nozzles 744 and the lower nozzles 747 provide the airflow 770 to the chamber 740. The intake 745 is provided at a lower portion of the sidewalls 722 for receiving the airflow 770 that has passed through the chamber 740. The diffuser 742, the nozzles 744 and the lower nozzles 747 are located to provide downwardly directed crosswise airflow into the chamber 740. The nozzles 744 and the lower nozzles 747 being paired allows consistent and even airflow through the chamber 740.

The nozzles 744 and the lower nozzles 747 are angled and situated relative to the diffuser 742 to converge the airflow 770 on a selected location in the chamber 740, such as toward beds 788. The nozzles 744 and the lower nozzles 747 may be arranged in opposed 45 degree angles as shown, or in any pair of matched and horizontally opposed angles that will, in combination with the converge the airflow in the chamber 740. The nozzles 744 and the lower nozzles 747 may be adjustable to position the airflow as desired by a user of the airflow system 710.

The nozzles 744, the lower nozzles 747 and the diffuser 742 are fed with the incoming airflow 778 from the second plenum 736. The diffuser 742, the nozzles 744 and the lower nozzles 747 provide the airflow 770 downwardly and in crosswise opposition into the chamber 740. The diffuser 742 provides the downward airflow 772 in a vertically downward direction. The nozzles 744 and the lower nozzles 747 provide the angled airflow 774 at two angles that are substantially equal in their respective vertical components, and opposed across a width of the chamber 740 in their respective horizontal components. The horizontal opposition of the first angle and the second angle across the width of the chamber 740 evens out the airflow 770 horizontally.

The system 710 includes an airflow source, which is not shown in FIGS. 43 to 45 for clarity of the other features in FIGS. 43 to 45. The airflow source in airflow communication with the second plenum 736 for providing the incoming airflow 778. After the airflow 770 passes through the chamber 740, the airflow 770 enters the intakes 745.

The airflow source may be in airflow communication with the first plenum 732 for receiving the outgoing airflow 776 to be recirculated as incoming airflow 778 in a closed system. The outgoing airflow 776 flows through the first plenum 732 to the second plenum 736 and the incoming airflow 778 flows through the second plenum 736 to be reintroduced into the chamber 740 by the diffuser 742, the nozzles 744 and the lower nozzles 747. Alternatively, The outgoing airflow 776 may be vented externally and expelled from the motor vehicle, in which case the incoming airflow 778 may be sourced from externally to the motor vehicle in an open system. Each of these approaches to the outgoing airflow 776 may be applied in the same system with selectable changes in the airflow path allowing selection of open or closed loop systems.

In addition to the airflow source, the system 710 may include a conditioning system in airflow communication with the first plenum 732 and the second plenum 736. FIGS. 43 to 45 does not show the conditioning units, which may be optionally included. Motor vehicles typically include climate control and the onboard climate control may play the role of the conditioning units.

Conditioning units may be used with the system 710. FIG. 43 does not show the conditioning units, which may be optionally included. Alternatively, the outgoing airflow 776 may be expelled from the motorhome and the incoming airflow 778 may be sourced from externally to the motorhome. Motorhomes typically include climate control and the onboard climate control may play the role of the conditioning units.

Where the conditioning units are applied to the airflow system 710 that is a closed system, the first plenum 732 provides airflow communication between the chamber 740 and the conditioning units, and the second plenum 736 provides airflow communication between the conditioning units and the chamber 740. Where the conditioning units are applied to the airflow system 710, the volume of the first plenum 732 is equal to the volume within the second plenum 736. The cross-sectional area of the first plenum 732 within the sidewalls 722, and the cross-sectional area of the second plenum 736 within the roof component 724 provide variables to equalize the volume of the first plenum 732 with the volume within the second plenum 736.

The conditioning units may include water droplet removal systems, particulate filters (e.g. a foam filter, etc.), chemical purification filters other approaches to removing volatile or suspended organic compounds (e.g. activated carbon filter, carbon plate, activated charcoal filter, a HEPA filter etc.), humidity exchangers for increasing or decreasing humidity, heat exchangers for heating or cooling the airflow, or combinations of the foregoing. Cooling or heating of the airflow, addition of humidity and other conditioning takes place downstream of the conditioning units in the second plenum 736.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A cultivation system comprising:
a body defining a sealed cultivation chamber therein;
an output on the body for directing airflow downwardly and in crosswise opposition into the chamber;
an intake below the output for receiving the airflow from the output;
a conduit between the intake and the output for providing airflow communication from the intake to the output;
a conditioning system in airflow communication with the conduit for conditioning the airflow after being received by the intake for return to the output; and
an input in airflow communication with the conduit for providing additional input material to the conduit;
wherein:
the cross-sectional area of the output is substantially equal to the cross-sectional area of the intake for maintaining consistent airflow within the chamber; and
a first portion of the conduit between the intake and the conditioning system is substantially equal in volume to a second portion of the conduit between the conditioning system and the output.

2. The system of claim 1 wherein the body comprises modular components connected with each other.

3. The system of claim 2 wherein the modular components comprise a first endwall, a second endwall, at least two sidewalls, at least one floor component and at least one roof component.

4. The system of claim 3 wherein the first endwall includes a doorway for access to the chamber.

5. The system of claim 4 wherein the chamber is overpressured to a first pressure that is greater than atmospheric pressure.

6. The system of claim 4 further comprising an antechamber component connected to the body at the first endwall.

7. The system of claim 6 wherein the chamber is overpressured to a first pressure that is greater than atmospheric pressure.

8. The system of claim 7 wherein the antechamber is overpressured to a second pressure that is greater than atmospheric pressure and that is below the first pressure.

9. The system of any one of claims 3 to 8 wherein each of the at least one of the floor components slopes downwardly from a first end to a second end at a grade along a sloped portion, and each of the at least one floor components comprises a drain at the second end.

10. The system of claim 9 wherein the at least one floor components comprise at least two floor components, the grade of each floor component is equal, a height at the first end of each floor component is equal, and a height at the second end of each floor component is equal, for resetting the height and the grade on each successive sloped portion.

11. The system of any of claims 9 to 10 further comprising a walkway panel reversibly mountable over the sloped portion and the drain of each floor component.

12. The system of any of claims 2 to 11 wherein the modular components include flanged connection points extending from each of the modular components externally to the body for connecting the components.

13. The system of any of claims 1 to 12 further comprising a plurality of cleaning orifices in the body for forcefully providing cleaning fluids to the chamber to clean and sanitize the chamber.

14. The system of claim 1 wherein the chamber is overpressured to a first pressure that is greater than atmospheric pressure.

15. The system of claim 14 further comprising an antechamber in the body for providing access to the chamber.

16. The system of claim 15 wherein the antechamber is overpressured to a second pressure that is greater than atmospheric pressure and that is below the first pressure.

17. The system of any of claims 1 to 16 wherein the output comprises:
a pair of nozzles located across at least a portion of the width of the chamber from each other for directing the airflow downwardly into the chamber at a first angle and at a second angle; and
a diffuser located intermediate the pair of nozzles along the width for directing the airflow downwardly into the chamber;
wherein the first angle and the second angle are substantially equal in the magnitudes of their respective horizontal and vertical components and opposed across a width of the chamber for converging within the chamber.

18. The system of claim 17 wherein the diffuser is located intermediate the pair of nozzles along the width for directing the airflow vertically downward into the chamber.

19. The system of claim 17 further comprising a plurality of pairs of nozzles and a plurality of diffusers; and
wherein each of the plurality of pairs of nozzles and each of the plurality of diffusers are regularly spaced located along a length of chamber, the length being perpendicular to the width;
each of the plurality of nozzles and diffusers is calibrated for greater cross-sectional area with increasing distance from to conditioning system for providing consistent output of airflow along the length of the chamber; and
the intake is calibrated to for greater cross-sectional area with increasing distance from the conditioning system for providing consistent intake of airflow along the length of the chamber.

20. The system of claim 19 wherein each diffuser of the plurality of diffusers is located intermediate a pair of nozzles of the plurality of pairs of nozzles along the width for directing the airflow vertically downward into the chamber.

21. The system of any of claims 17 to 20 wherein the first angle and the second angle are each equal to between 40 and 50 degrees.

22. The system of any of claims 17 to 20 wherein the first angle and the second angle are selected to converge the airflow from the pair of nozzles on a position or expected position of plants being cultivated in the chamber.

23. The system of any of claims 1 to 22 wherein the intake is on a downward-facing contour of the body to facilitate cleaning by spraying from above without spraying into the intake.

24. The system of any of claims 1 to 23 wherein the conduit comprises a first plenum extending along a length of the body from the intake to the conditioning system.

25. The system of claim 24 wherein the first plenum is defined within a sidewall of the body.

26. The system of claim 24 further comprising an outer shell within which the body is received and wherein the first plenum is defined between a sidewall and the outer shell.

27. The system of any of claims 24 to 26 wherein the conduit comprises a second plenum extending along a length of the body from the conditioning system to the output.

28. The system of claim 27 wherein the second plenum is defined on a roof of the body.

29. The system of claim 28 wherein the second plenum is defined within a roof component of the body.

30. The system of claim 28 further comprising an outer shell within which the body is received and wherein the second plenum is defined between a roof component of the body and the outer shell.

31. The system of any of claims 27 to 30 wherein the input is in airflow communication with a source of CO₂ and the second plenum.

32. The system of any of claims 1 to 31 wherein the second portion is located at an upper part of the body and above the output, and the input is in airflow communication with the second portion for providing the additional input material to the conduit input at the second portion.

33. The system of any of claims 1 to 32 wherein the conditioning system comprises a particulate filter.

34. The system of claim 33 wherein the conditioning system comprises a moisture droplet removal system intermediate the intake and the particulate filter.

35. The system of any of claims 33 to 34 wherein the conditioning system comprises a chemical purification filter intermediate the particulate filter and the output.

36. The system of any of claims 1 to 35 wherein the conditioning system comprises a heat exchanger for heating or cooling the airflow.

37. The system of claim 36 wherein the heat exchanger is in airflow communication with the conduit for heating or cooling the airflow in a portion of the conduit located above the output.

38. The system of any of claims 1 to 37 wherein the conditioning system comprises a humidity control system for raising or lowering the relative humidity of gas in the airflow.

39. The system of any of claims 1 to 30 or 32 to 38 wherein the input is in airflow communication with a source of CO₂.

40. The system of claim 39 wherein the input is in airflow communication with a portion of the conduit located above the output for providing airflow communication between the source of CO₂ and the portion of the conduit located above the output.

41. The system of any of claims 1 to 40 wherein the input is in airflow communication with a source of purified air.

42. The system of any of claims 1 to 41 further comprising a plurality of cleaning orifices in the body for forcefully providing cleaning fluids to the chamber to clean and sanitize the chamber.

43. A cultivation method comprising:
providing a sealed cultivation chamber;
directing conditioned airflow downwardly and in crosswise opposition into the chamber, resulting in spent airflow;
recovering the spent airflow from the chamber;
conditioning the spent airflow after being received from the chamber, resulting in the conditioned airflow; and
flowing the conditioned airflow toward the chamber for directing the conditioned airflow downwardly and in crosswise opposition into the chamber, resulting in the spent airflow;
wherein:
a volume of the conditioned airflow being directed into the chamber is substantially equal to a volume of the spent airflow being received from the chamber for maintaining consistent airflow within the chamber; and
a volume of the spent airflow between receiving the airflow and conditioning the airflow is substantially equal to a volume of the conditioned airflow between conditioning the airflow and a return to directing the airflow.

44. The method of claim 43 wherein the chamber is overpressured above atmospheric pressure.

45. The method of any of claims 43 to 44 wherein conditioning comprises filtering out particulates.

46. The method of any of claims 43 to 45 wherein conditioning comprises removing droplets.

47. The method of any of claims 43 to 46 wherein conditioning comprises controlling humidity.

48. The method of any of claims 43 to 47 wherein conditioning comprises applying chemical purification.

49. The method of any of claims 43 to 48 wherein conditioning comprises exchanging heat.

50. The method of claim 49 wherein exchanging heat to lower the temperature of the conditioned airflow is provided to the conditioned airflow above a point where the airflow is directed into the chamber.

51. The method of any of claims 43 to 50 further comprising providing additional input material to the conditioned airflow.

52. The method of claim 51 wherein the input material comprises CO₂.

53. The method of claim 52 wherein the CO₂ is provided to the conditioned airflow above a point where the airflow is directed into the chamber.

54. The method of any of claims 43 to 53 further comprising directing cleaning fluids under pressure into the chamber through a plurality of cleaning orifices and draining the fluids from the chamber.

55. The method of claim 54 wherein the cleaning fluid comprises a cleaning chemical in solvent.

56. The method of claim 55 wherein:
the cleaning chemical has a first boiling point;
the solvent has a second boiling point; and
the first boiling point is lower than the second boiling point; and
the method further comprises increasing the temperature in the chamber to a temperature between the first boiling point and the second boiling point for boiling the cleaning chemical and exposing the chamber to gaseous cleaning chemical.

57. The method of any one of claim 55 or 56 wherein the cleaning chemical comprises Cl₂ and the solvent comprises water.

58. A cultivation vessel comprising:
a tapered body extending between a narrow first end and a wide second end, the body defining a cavity therein for receiving growth medium and holding roots of a plant;
an aperture defined proximate the first end for accommodating a stalk of a plant growing from growth media in the cavity;
a mouth defined proximate the second end for receiving growth media and allowing fluids to drain from the body; and
a lid for connecting with the mouth for holding the growth medium within the cavity;
wherein the aperture is narrower than the mouth; and
the body is tapered for facilitating flow of particles downward along the body.

59. The cultivation vessel of claim 58 wherein the aperture is at the first end.

60. The cultivation vessel of any of claims 58 to 59 further comprising a plug in the aperture for mitigating entry of infectious particles into cavity.

61. An airflow system comprising:
a body defining a chamber therein;
an output on the body for directing airflow downwardly and in crosswise opposition into the chamber;
an intake below the output for receiving the airflow from the output; and
an airflow source in airflow communication with the output;
wherein the cross-sectional area of the output is substantially equal to the cross-sectional area of the intake for maintaining consistent airflow within the chamber.

62. The system of claim 61 wherein the output comprises:
a pair of nozzles located across at least a portion of the width of the chamber from each other for directing the airflow downwardly into the chamber at a first angle and at a second angle; and
a diffuser located intermediate the pair of nozzles along the width for directing the airflow downwardly into the chamber;
wherein the first angle and the second angle are substantially equal in the magnitudes of their respective horizontal and vertical components and opposed across a width of the chamber for converging within the chamber.

63. The system of claim 62 wherein the diffuser is located intermediate the pair of nozzles along the width for directing the airflow vertically downward into the chamber.

64. The system of claim 62 further comprising a plurality of pairs of nozzles and a plurality of diffusers; and
wherein each of the plurality of pairs of nozzles and each of the plurality of diffusers are regularly spaced located along a length of chamber, the length being perpendicular to the width;
each of the plurality of nozzles and diffusers is calibrated for greater cross-sectional area with increasing distance from to airflow source for providing consistent output of airflow along the length of the chamber; and
the intake is calibrated to for greater cross-sectional area with increasing distance from the airflow source for providing consistent intake of airflow along the length of the chamber.

65. The system of claim 63 wherein each diffuser of the plurality of diffusers is located intermediate a pair of nozzles of the plurality of pairs of nozzles along the width for directing the airflow vertically downward into the chamber.

66. The system of any of claims 62 to 65 wherein the first angle and the second angle are each equal to between 40 and 50 degrees.

67. The system of any of claims 62 to 65 wherein the first angle and the second angle are selected to converge the airflow from the pair of nozzles on a target position in the chamber.

68. The system of any of claims 61 to 67 wherein the intake is on a downward-facing contour of the body to facilitate cleaning by spraying from above without spraying into the intake.

69. The system of any of claims 61 to 68 further comprising an input in airflow communication with the output for providing input material to the output.

70. The system of any of claims 61 to 68 further comprising a conduit between the intake and the output for providing airflow communication from the intake to the output.

71. The system of claim 70 wherein the conduit comprises a first plenum extending along a length of the body from the intake to the airflow source.

72. The system of claim 71 wherein the first plenum is defined within a sidewall of the body.

73. The system of claim 72 wherein the conduit comprises a second plenum extending along a length of the body from the airflow source to the output.

74. The system of claim 73 wherein the second plenum is defined on a roof of the body.

75. The system of claim 74 wherein the second plenum is defined within the roof.

76. The system of claim 74 further comprising a covering over the roof and wherein the second plenum is defined between the roof and the covering.

77. The system of any of claims 70 to 76 further comprising an input in airflow communication with the conduit, and in airflow communication with a source of input material for providing additional input material to the conduit.

78. The system of claim 77 wherein the input is in airflow communication with the conduit at a portion of the body above the output.

79. The system of any one of claims 77 to 78 wherein the input material comprises purified air.

80. The system of any one of claims 77 to 79 wherein the input material comprises scented material or coloured material.

81. The system of any one of claims 77 to 80 wherein the input is in airflow communication with a portion of the conduit located above the output for providing airflow communication between the source of input material and the portion of the conduit located above the output.

82. The system of any of claims 70 to 81 further comprising a conditioning system in airflow communication with the conduit for conditioning the airflow after being received by the intake for return to the output and wherein a first portion of the conduit between the intake and the conditioning system is substantially equal in volume to a second portion of the conduit between the conditioning system and the output.

83. The system of claim 82 wherein the conditioning system is integrated with the airflow source.

84. The system of any one of claim 82 or 83 wherein the conditioning system comprises a particulate filter.

85. The system of any of claims 82 to 84 wherein the conditioning system comprises a moisture droplet removal system intermediate the intake and the particulate filter.

86. The system of any of claims 82 to 85 wherein the conditioning system comprises a chemical purification filter intermediate the particulate filter and the output.

87. The system of any of claims 82 to 86 wherein the conditioning system comprises a heat exchanger for heating or cooling the airflow.

88. The system of claim 87 wherein the heat exchanger is in airflow communication with the conduit for heating or cooling the airflow in a portion of the conduit located above the output.

89. The system of any of claims 82 to 88 wherein the conditioning system comprises a humidity control system for raising or lowering the relative humidity of gas in the airflow.

90. An airflow method comprising:
providing a chamber;
directing incoming airflow downwardly and in crosswise opposition into the chamber, resulting in outgoing airflow; and
recovering the outgoing airflow from the chamber;
wherein a volume of the incoming airflow being directed into the chamber is substantially equal to a volume of the outgoing airflow being received from the chamber for maintaining consistent airflow within the chamber.

91. The method of claim 90 further comprising providing input material to the incoming airflow.

92. The method of claim 91 wherein the input material comprises purified air.

93. The method of any one of claims 91 to 92 wherein the input material comprises scented material or coloured material.

94. The method of any of claims 91 to 93 wherein the additional input material is provided to the airflow above a point where the airflow is directed into the chamber.

95. The method of any of claims 90 to 94 wherein recovering the outgoing airflow comprises flowing the outgoing airflow back to the chamber as incoming airflow.

96. The method of claim 95 further comprising conditioning the outgoing airflow after being received from the chamber, resulting in conditioned airflow; and
flowing the conditioned airflow toward the chamber for directing the conditioned airflow downwardly and in crosswise opposition into the chamber, resulting in the spent airflow; and
wherein the volume of the spent airflow between receiving the outgoing airflow and conditioning the outgoing airflow is substantially equal to the volume of the conditioned airflow between conditioning the airflow and a return to directing the airflow.

97. The method of claim 96 wherein conditioning comprises filtering out particulates.

98. The method of any of claims 96 to 97 wherein conditioning comprises removing droplets.

99. The method of any of claims 96 to 98 wherein conditioning comprises controlling humidity.

100. The method of any of claims 96 to 99 wherein conditioning comprises applying chemical purification.

101. The method of any of claims 96 to 100 wherein conditioning comprises exchanging heat.

102. The method of claim 101 wherein exchanging heat to lower the temperature of the conditioned airflow is provided to the conditioned airflow above a point where the airflow is directed into the chamber.
